(19) United States
(12) Patent Application Publication
(10) Pub. No.: US 2024/0106655 A1
(43) Pub. Date: Mar. 28, 2024

(54) APPARATUSES, COMPUTER-IMPLEMENTED METHODS, AND COMPUTER PROGRAM PRODUCTS FOR REAL-TIME VIRTUAL OBJECT DIGITAL SIGNING AND DIGITAL ASSET GENERATION

(71) Applicants: Jun YING, Atlanta, GA (US); Bradley William ORN, Duluth, MN (US); Harrison Hunter ABRAMSON, Lakeland, FL (US); Kenneth Steven LAUER, Oakland, CA (US)

(72) Inventors: Jun YING, Atlanta, GA (US); Bradley William ORN, Duluth, MN (US); Harrison Hunter ABRAMSON, Lakeland, FL (US); Kenneth Steven LAUER, Oakland, CA (US)

(21) Appl. No.: 17/934,755

(22) Filed: Sep. 23, 2022

(51) Int. Cl. H04L 9/32; G06F 21/16; G06F 21/64; G06T 17/00; G06V 20/40

(52) U.S. Cl. CPC H04L 9/3247; G06F 21/16; G06F 21/64; G06T 17/00; G06V 20/46

(57) ABSTRACT

Embodiments of the present disclosure relate to real-time digitally signing of a virtual object. The real-time digital signing of a virtual object is provided in a multi-user real-time context between signor and signee that enables the signor to perform the real-time digital signing and the signee to visually experience the real-time signing. The real-time digital signing may be provided to the signor and signee in parallel, and/or one or more additional viewers taking part in the digital signing. Upon completion of the digital signing, some embodiments in near-real-time generate a digital asset that is linked to the virtual object modified with the digital signature, which may be assigned to and/or otherwise linked with the signee for subsequent retrieval and/or use.

### TECHNOLOGICAL FIELD

Embodiments of the present disclosure generally relate to digital signing and/or “e-signing,” and specifically to real-time environments that enable a signor and signee to take part in the signing simultaneously and generate a resulting digital asset, such as a token including a non-fungible token (“NFT”) or other digital data linked to the signed virtual object.

### BACKGROUND

In several contexts, a signing is performed for any of a myriad of reasons. In many of such contexts, however, a physical signing of an item is either impractical, impermissible, or simply impossible. Simple e-signing, while possible for some objects, does not enable the recipient of the signature to take part in the signing process, thereby losing access to the signing experience and any benefits thereof.

Applicant has discovered problems with current implementations of digitally signing virtual objects. Through applied effort, ingenuity, and innovation, Applicant has solved many of these identified problems by developing embodied in the present disclosure, which are described in detail below.

### BRIEF SUMMARY

In general, embodiments of the present disclosure are provided for real-time digital signing of virtual object(s). Other implementations for real-time digital signing of virtual object(s) will be, or will become, apparent to one with skill in the art upon examination of the following figures and detailed description. It is intended that all such additional implementations be included within this description be within the scope of the disclosure, and be protected by the following claims.

In accordance with a first aspect of the disclosure, a computer-implemented method for real-time digitally signing a virtual object is provided. The computer-implemented method is executable via any of a myriad of computing device(s) embodied in hardware, software, firmware, and/or any combination thereof, as described herein. One example computer-implemented method includes receiving a virtual object. The example computer-implemented method further includes simultaneously causing displaying of the virtual object to at least a digital signor device and a digital signee device. The example computer-implemented method further includes simultaneously causing displaying, at each of the digital signor device and the digital signee device, of (1) first live video data associated with the digital signor device, and (2) second live video data associated with the digital signee device. The example computer-implemented method further includes receiving digital signature tracking data representing a digital signature input via the digital signor device, where the digital signature tracking data is associated with positional data relative to the virtual object. The example computer-implemented method in near-real-time, causing displaying of the digital signature tracking data at least at the digital signee device. The example computer-implemented method further causing generation, in near-real-time, of a non-fungible token representing the virtual object and the digital signature, the non-fungible token digitally linked to a signee identifier associated with the digital signee device.

In some embodiments of the example computer-implemented method, receiving the virtual object includes receiving the virtual object via an upload from the digital signee device.

In some embodiments of the example computer-implemented method, receiving the virtual object includes receiving the virtual object via an upload from the digital signor device.

In some embodiments of the example computer-implemented method, the example computer-implemented method further includes simultaneously causing displaying of the virtual object and the digital signature tracking data to at least one additional viewer device.

In some embodiments of the example computer-implemented method, the example computer-implemented method further includes simultaneously causing displaying, to at least one additional viewer device, of (1) the first live video data and (2) the second live video data.

In some embodiments of the example computer-implemented method, the example computer-implemented method further includes authenticating a user identity associated with the digital signor device, wherein the user identity is authenticated via at least one social media account. In some such embodiments of the example computer-implemented method the user identity is authenticated via a plurality of social media accounts.

In some embodiments of the example computer-implemented method, the example computer-implemented method further includes authenticating a user identity associated with the digital signee device.

In some embodiments of the example computer-implemented method, the example computer-implemented method further includes maintaining a signee device queue comprising a plurality of devices representing a user queue and establishing a connection with a next device from the signee device queue, wherein the next device embodies the digital signee device during the connection. In some such embodiments of the example computer-implemented method, the connection is established associated with the digital signor device and the digital signee device is updated one at a time via the signee device queue.

In some embodiments of the example computer-implemented method, the example computer-implemented method further includes authenticating the non-fungible token associated with a particular user device, and granting access associated with the particular user device based at least in part on authentication of the non-fungible token.

In some embodiments of the example computer-implemented method, the first live video data comprises a captured video associated with a signor during input of the digital signature input.

In some embodiments of the example computer-implemented method, the example computer-implemented method further includes providing at least one control for manipulating the digital signature with respect to the virtual object.

In accordance with a second aspect of the present disclosure, an apparatus for real-time digitally signing a virtual object is provided. In one example embodiment of the apparatus, the example apparatus includes at least one processor and at least one memory having computer program code stored thereon that, in execution with at least one processor, performs any one of the example computer-implemented methods described herein. In another example embodiment of the apparatus, the example apparatus includes means for performing each step of any one of the example computer-implemented methods described herein.

In accordance with a third aspect of the present disclosure, a computer program product for real-time digitally signing a virtual object is provided. In one example embodiment of the computer program product, the example computer program product includes at least one non-transitory computer-readable storage medium having computer program code stored thereon that, in execution with at least one processor, configures the computer program product for performing any one of the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate;

FIG. 2 illustrates a block diagram of an example real-time digital signing apparatus that may be specially configured in accordance with an example embodiment of the present disclosure;

FIG. 3 illustrates a block diagram of an example real-time signee apparatus that may be specially configured in accordance with an example embodiment of the present disclosure;

FIG. 4 illustrates a block diagram of an example real-time signor apparatus that may be specially configured in accordance with an example embodiment of the present disclosure;

FIGS. 5A and 5B illustrates a data flow between example devices associated with a signee device queue in accordance with at least one example embodiment of the present disclosure;

FIG. 6 illustrates a visualization of device connectivity during real-time signing of a virtual object in accordance with at least one example embodiment of the present disclosure;

FIG. 7 illustrates a sequence diagram of operations performed during real-time signing of a virtual object in accordance with at least one example embodiment of the present disclosure;

FIG. 8A illustrates an example signee interface in accordance with at least one example embodiment of the present disclosure;

FIG. 8B illustrates an example signor interface in accordance with at least one example embodiment of the present disclosure;

FIG. 9 illustrates a flowchart depicting operations of at least one example process for real-time digitally signing a virtual object in accordance with at least one example embodiment of the present disclosure;

FIG. 10 illustrates a flowchart depicting operations of at least one example process for receiving a virtual object, for example as a part of a process for real-time digitally signing a virtual object, in accordance with at least one example embodiment of the present disclosure;

FIG. 11 illustrates a flowchart depicting operations of at least one example process for causing displaying to at least one viewer device, for example as part of a process for real-time digitally signing a virtual object, in accordance with at least one example embodiment of the present disclosure;

FIG. 12 illustrates a flowchart depicting operations of at least one example process for user authentication, for example as part of a process for real-time digitally signing a virtual object, in accordance with at least one example embodiment of the present disclosure;

FIG. 13 illustrates a flowchart depicting operations of at least one example process for managing a signee queue, for example as part of a process for real-time digitally signing a virtual object, in accordance with at least one example embodiment of the present disclosure; and

FIG. 14 illustrates a flowchart depicting operations of at least one example process for facilitating access based at least in part on authentication of a token, such as an NFT associated with a digitally signed virtual object, for example as part of a process for real-time digitally signing a virtual object, in accordance with at least one example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Items in the real-world are often signed for any of a myriad of reasons. In some circumstances, an item is signed for purposes of indication of possession, review, or other interaction by the signor, such that the signature can be subsequently reviewed for authentication and/or certification. In other circumstances, however, an item is signed for purposes of memorabilia, to increase the item's value due to the fame of the person signing, and the like. One such instance of such signing is with respect to celebrity culture, sports memorabilia, and autographs of other high-profile individuals that are otherwise desirable to people and/or derive value to the items that are signed. In many of such circumstances, those receiving the signature have particular items in mind for signing, for example a trading card for signature by the player depicted, a picture with a famous individual for signature by the famous individual, or the like.

The advent of digital collectibles has introduced a myriad of problems. In several circumstances, an individual may desire to have a virtual object signed, for example instead of or in addition to a real-world item. In some circumstances however, no real-world signing may be possible, such as due to pandemic conditions, distance between the signor and signee, and the like. Most platforms do not provide access to any digital signing at all between users. Any such digital signing of virtual objects often lacks sufficient proof that a user is who they assert to be. Further still, digital signatures are often stolen, cut, or otherwise ripped from existing versions and placed—without the signor's authority, intent, and/or action—on a new virtual object as a counterfeit signature without means for authentication, Further still, even if a platform provided all such authentication and security measures in place, the recipient of the signature is often left out of the process, and thereby does not get to take part of or enjoy any of the signing process, interacting with the signor, and the like. Conventional digital signature platforms provide no joy at all.

Embodiments of the present disclosure provide improved real-time digital signing of virtual objects. Such embodiments enable a joint session that is accessible at least by the signor and signee in real-time, as well as optionally any number of additional viewers. Via the joint session, the signor and/or signee may upload a virtual object to be signed by the signee, and see the virtual object once uploaded. The signor may then digitally sign the virtual object, with at least the signee (and/or optional viewers) seeing indication of the input(s) resulting in the digital signature in real-time as they occur. During the process, the signor and signee may continuously interact, for example via a chat feature, real-time live streams, and/or the like, and/or in some embodiments the additional viewer(s) may interact as well through a chat and/or similar features. Once the digital signing process is completed, embodiments in near-real-time generate a digital token, such as an NFT or other token linked with the virtual object modified with the digital signature. The token or NFT is linked to an account or identifier associated with the signee, such that the signee may utilize, view, and/or store the token or NFT for any period of time.

In this regard, embodiments of the present disclosure provide a myriad of technical advantages. Embodiments utilize digital authentication and validation to authenticate user identities and accounts during the digital signing process. Utilizing cryptography, embodiments create a unique resource that identifies the particular digitally signed virtual object in a manner that is authenticatable by the signee and others. Further, the real-time experiential manner in which embodiments facilitate the digital signing process provides additional authentication that the signee is in fact who they assert to be during the process that resulted in the digital signature. Each of these technical advantages is provided in a manner that further allows both signee and signor to take part in the digital signing experience in a manner that increases enjoyment of the process itself.

### Definitions

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” “electronic information,” “signal,” “command,” and similar terms may be used interchangeably to refer to data capable of being captured, transmitted, received, and/or stored in accordance with various embodiments of the present disclosure. Thus, use of any such terms should not be taken to limit the spirit and scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, repeaters, and/or the like, sometimes referred to herein as a “network.” Similarly, where a first computing device is described herein as sending data to a second computing device, it will be appreciated that the data may be sent or transmitted directly to the second computing device or may be sent or transmitted indirectly via one or more intermediary computing devices, such as, for example, one or more servers, remote servers, cloud-based servers (e.g., cloud utilities), relays, routers, network access points, base stations, hosts, repeaters, and/or the like.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including” and variants thereof are used in either the detailed description or the claims, these terms are intended to be inclusive in a manner similar to the term “comprising.”

The phrases “in one embodiment,” “according to one embodiment,” “in some embodiments,” and the like generally refer to the fact that the particular feature, structure, or characteristic following the phrase may be included in the at least one embodiment of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

As used herein, the term “system” refers to computer hardware or a combination of computer hardware and software that is configured (either physically or by the execution of software) to collect and/or generate sensor data of the present disclosure and, among various other functions, is configured to directly, or indirectly, transmit and receive data. In some embodiments, the system may be configured to communicate with the other computing devices via Bluetooth, NFC, Wi-Fi, 3G, 4G, 5G, RFID protocols, and the like.

Additionally, as used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

The term “signor” refers to any entity that provides digital signature.

The term “signee” refers to any entity that receives data embodying or representing a virtual object signed with or otherwise linked to a digital signature embodied based at least in part on digital signature tracking data provided by a particular signor.

The term “virtual object” refers to electronically managed data embodying a displayable image or other renderable data.

The term “digitally signing” refers to inputting one or more signal(s) via user input that represents strokes of a particular digital signature embodying a user's signature. The resulting digital signature in some embodiments is stored as image data upon completion.

The term “session” refers to electronically managed data that enables multiple user devices to view, access, and/or interact with shared data in a real-time manner. In some embodiments, a session refers to data that facilitates a digital signing between a signor and a signee, and optionally one or more viewer(s).

The term “digital signor device” refers to hardware, software, firmware, and/or a combination thereof that is authenticated associated with a particular signor, where the digital signor device is usable to access a session that enables signing of one or more virtual object(s).

The term “digital signee device” refers to hardware, software, firmware, and/or a combination thereof that is authenticated associated with a particular signee, where the digital signee device is usable to access a session that enables receiving a digital signature linked to one or more virtual object(s).

The term “viewer device” refers to hardware, software, firmware, and/or a combination thereof, that is authenticated associated with a particular user account, identifier, or other identity, where the viewer device is usable to access a session that enables viewing of a digital signing process between at least one digital signee device and at least one digital signor device.

The term “live video data” refers to video data and/or image frames that are captured, transmitted, and/or displayed in a real-time manner. In some embodiments live video data is captured via a webcam, an integrated camera, or another optics peripheral electronically coupled for communication with a computing device.

The term “digital signature” refers to electronically managed data representing a renderable image version of a signor's signature. In some embodiments, a digital signature is embodied by image data, scalable vector graphic data, and/or pen stroke position and/or attribute data that represents a completed signature.

The term “digital signature tracking data” refers to electronically managed data representing individual strokes of a digital signature being performed in real-time or near-real-time via input to a digital signor device. In some embodiments, digital signature tracking data represents position and/or visual attribute data of each input, stroke, gesture, or other input received via the digital signor device.

The term “positional data” refers to electronically managed data representing a point, size, location, and/or bounding box of particular data renderable within a particular coordinate system. In some embodiments, positional data represents a location of digital signature tracking data representing a pen stroke relative to a coordinate system defining a boundary box of a virtual object.

The term “real-time” refers to occurrence of an action or process simultaneously with, barring minimal transmission time over a communication network, one or more other action(s) and/or process(es). For example, rendering at two devices in real-time in some embodiments includes rendering of data at a first device, transmission of the data across a communication network to a second device, and subsequent rendering of data at a second device, which may occur in milliseconds from one another.

The term “near-real-time” refers to the occurrence of an action or process with one or more other action(s) or process(es) that is completed based on a time for completion of a single process. It will be appreciated that the single process may include any number of sub-processes.

The term “signee identifier” refers to electronically managed data that uniquely identifies a particular entity authenticated as a signee associated with a digital signee device.

The term “signee device queue” refers to at least one data structure including electronically managed data representing an ordered list of any number of digital signee devices to engage in digital signing with one or more digital signor device(s) during a particular session or plurality of sessions.

The term “next device” with respect to a signee device queue refers to electronically managed data representing a digital signee device that is not currently participating in a digital signing via a session, and is in a particular position within the signee device queue that indicates that the digital signee device is indicated to participate next in the digital signing during the session.

The term “user queue” refers to an ordered list of users representing signees to participate in a digital signing process during a particular session, each signee corresponding to a particular digital signee device.

The term “access” with respect to a particular user identifier and/or device refers to a state of permission determinable based at least in part on whether authentication of a particular token is successful as associated with that particular user identifier.

The term “manipulation” with respect to a digital signature refers to one or more image processing operations performable on the digital signature to alter, move, adjust, erase, and/or otherwise change one or more visual aspects or content of the digital signature or any portion thereof.

### Exemplary Systems and Apparatuses

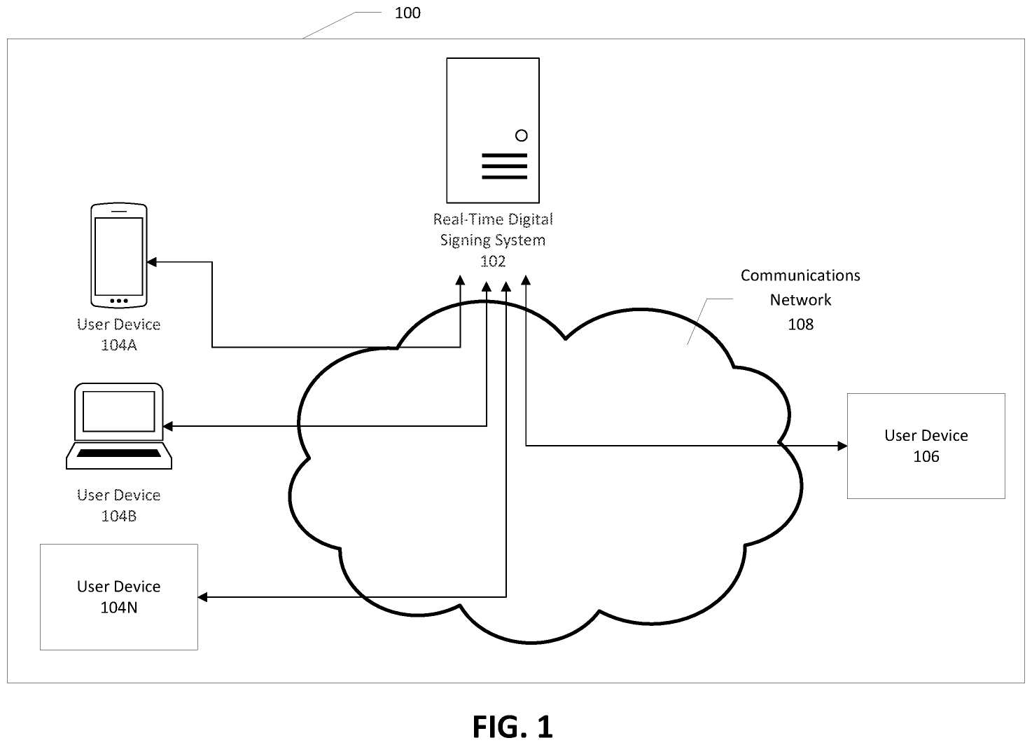

FIG. 1 illustrates a block diagram of a system that may be specially configured within which embodiments of the present disclosure may operate. Specifically, FIG. 1 illustrates a system 100 specially configured for real-time digitally signing a virtual object. As depicted, the system 100 includes a real-time digital signing system 102, one or more user devices 104A-104N, and at least one user device 106. In some embodiments, each of the one or more user devices 104A-104N embody a digital signee device. Additionally or alternatively, in some embodiments, the user device 106 embodies a digital signor device. In this regard, the depicted devices in some embodiments are associated with a particular digital signing session. In some embodiments, the system 100 includes a plurality of digital signee devices associated with each of a plurality of digital signor devices, for example each digital signor device corresponding to a different real-time digital signing session.

In some embodiments, the real-time digital signing system 102 includes one or more computing device(s) that facilitates a real-time digital signing of a virtual object. In some embodiments, the real-time digital signing system 102 includes at least one application server that facilitates a session that connects a particular digital signor device and at least one digital signee device, and optionally one or more additional viewer device(s). Additionally or alternatively, in some embodiments, the real-time digital signing system 102 includes one or more computing device(s) that facilitate generation of a digital asset or token, such as an NFT, representing a digitally signed virtual object. Additionally or alternatively, in some embodiments, the real-time digital signing system 102 includes one or more database(s) and/or database server(s) that maintain data utilized to provide such functionality. For example, in some embodiments, the database(s) may maintain user account data, ongoing session data, metric data, and/or the like. In some embodiments, the real-time digital signing system 102 includes or is embodied by one or more specially configured back-end server(s), cloud computing server(s), enterprise terminal(s), and/or the like.

In some embodiments, each user device 104A-104N embodies at least one specially configured computing device embodied in hardware, software, firmware, and/or a combination thereof. Each such user device enables performance of functionality of a digital signee during at least one real-time digital signing process. For example, in some embodiments, each user device 104A-104N enables joining of a session associated with a particular digital signor, joining a signee device queue associated with a particular digital signor, uploading of a particular virtual object, transmission of live video data, interacting via a live chat associated with a particular session, and/or the like. In some embodiments, each user device embodies a single hardware device configured via software and/or firmware for use by an end user. Non-limiting examples of a user device of the user devices 104A-104N includes, without limitation, a smartphone, a tablet, a personal computer, a laptop, a smart television, an Internet-of-Things enabled device, a virtual reality headset, an augmented reality display, and/or the like. In some embodiments, a user may access a particular user device and provide particular identifying information to authenticate their identity, and begin a particular authenticated session for accessing functionality of the real-time digital signing system 102 associated with that particular identity, user account, and/or other user identifier, for example upon authenticating that the user is a particular digital signee.

In some embodiments, each user device 106 embodies at least one specially configured computing device embodied in hardware, software, firmware, and/or a combination thereof. Each such user device enables performance of functionality of a digital signor during at least one real-time digital signing process. For example, in some embodiments, each user device 106 enables initiation of a session for joining by corresponding digital signee device(s), enables upload of a virtual object, enables input of a digital signature associated with a virtual object, transmission of live video data, interacting via a live chat, and/or the like. In some embodiments, each user device 106 embodies a single hardware device configured via software and/or firmware for use by an end user, for example for functionality of a digital signor device. Non-limiting examples of a user device 106 include, without limitation, a smartphone, a tablet, a personal computer, a laptop, a smart television, an Internet-of-Things enabled device, a virtual reality headset, an augmented reality display, and/or the like. In some embodiments, a user may access a particular user device and provide particular identifying information to authenticate their identity, and begin a particular authenticated session for accessing functionality of the real-time digital signing system 102 associated with that particular identity, user account, and/or other user identifier, for example upon authenticating that the user is a particular digital signor.

In some embodiments, the various devices of the system 100 over a communications network 108. For example, in some embodiments, the real-time digital signing system 102 is communicable with the user devices 104A-104N and/or user device 106 via Wi-Fi, the Internet, or another public or private communications network that may span a large area. In some such embodiments, the devices communicate via a shorter-range communications network, for example Bluetooth low energy or the like. Alternatively or additionally, in some embodiments devices communicate over any wired, wireless, long-range, and/or short-range wireless communications network(s).

The communications network 108 as described in some embodiments is embodied in any of a myriad of network configurations. In some embodiments, the communications network 108 embody a public network (e.g., the Internet). In some embodiments, the communications network 108 embodies a private network (e.g., an internal, localized, or closed-off network between particular devices). In some other embodiments, the communications network 108 embody a hybrid network (e.g., a network enabling internal communications between particular connected devices and external communications with other devices). The communications network 108 in some embodiments includes one or more base station(s), relay(s), router(s), switch(es), cell tower(s), communications cable(s) and/or associated routing station(s), and/or the like. In some embodiments, the communications network 108 includes one or more user controlled computing device(s) (e.g., a user owner router and/or modem) and/or one or more external utility devices (e.g., Internet service provider communication tower(s) and/or other device(s)).

The computing device(s) each may communicate over a whole or a portion of one or more communications network(s), such as the communication network 108. For example, each of the components of the system communicatively coupled to transmit data to and/or receive data from, for example, one another over the same or different wireless or wired networks embodying the communications network(s). Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network(s), the various embodiments are not limited to this particular architecture. In other embodiments, one or more computing entities share one or more components, hardware, and/or the like, or otherwise are embodied by a single computing device such that connection(s) between the computing entities are over the communications network(s) are altered and/or rendered unnecessary. Alternatively or additionally still, in some embodiments the communications network 108 enable communication to one or more other computing device(s) not depicted, for example client device(s) for accessing functionality of any of the subsystems therein via native and/or web-based application(s), and/or the like.

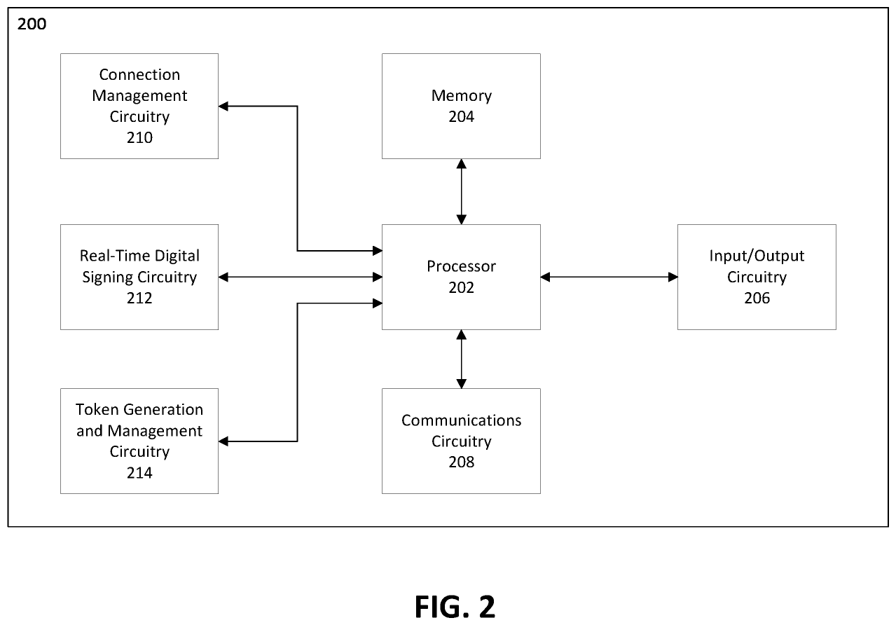

FIG. 2 illustrates a block diagram of an example real-time digital signing apparatus that may be specially configured in accordance with an example embodiment of the present disclosure. Specifically, FIG. 2 illustrates an example improved real-time digital signing apparatus 200 (“apparatus 200”) specially configured in accordance with at least one example embodiment of the present disclosure. In some embodiments, the real-time digital signing system 102, and/or a portion thereof, is embodied by one or more system(s), device(s), and/or the like, such as the apparatus 200 as depicted and described in FIG. 2. The apparatus 200 includes processor 202, memory 204, input/output circuitry 206, communications circuitry 208, connection management circuitry 210, real-time digital signing circuitry 212, and token generation and management circuitry 214. In some embodiments, the apparatus 200 is configured, using one or more of the sets of circuitry 202, 204, 206, 208, 210, 212, and/or 214, to execute and perform one or more of the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed.

As one particular example embodiment, the processor 202 is configured to perform various operations associated with real-time digital signing of virtual object(s). In some embodiments, the processor 202 includes hardware, software, firmware, and/or a combination thereof, that authenticates a user identity associated with one or more device(s), and/or associates a device with a user identity during a particular authenticated session. Additionally or alternatively, in some embodiments, the processor 202 includes hardware, software, firmware, and/or a combination thereof, that initiates a session associated with a particular digital signor corresponding to a particular digital signor device, where the session is joinable by at least one digital signee associated with a digital signee device and/or at least one additional viewer associated with an additional viewer device. Additionally or alternatively, in some embodiments, the processor 202 includes hardware, software, firmware, and/or a combination thereof, that facilitates input of a digital signature for applying to a virtual object. Additionally or alternatively, in some embodiments, the processor 202 includes hardware, software, firmware, and/or a combination thereof, that receives and maintains simultaneous displaying of data between at least a digital signor device and a digital signee device associated with the session, for example live video data, digital signature tracking data, chat data, uploaded virtual object(s), and/or the like. Additionally or alternatively, in some embodiments, the processor 202 includes hardware, software, firmware, and/or a combination thereof, that maintains a signee device queue associated with a particular session and/or corresponding digital signor device. Additionally or alternatively, in some embodiments, the processor 202 includes hardware, software, firmware, and/or a combination thereof, that generates a digital asset or token, such as an NFT, embodying a virtual object modified with or otherwise linked to a digital signature, and linking of the digital asset or token, such as the NFT, with a particular signee identifier.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user. In some embodiments, the input/output circuitry 206 includes hardware, software, firmware, and/or a combination thereof, that facilitates simultaneously display of particular data via a plurality of different devices.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from a client device, capture device, and/or other external computing device in communication with the apparatus 200.

In some embodiments, the apparatus 200 includes connection management circuitry 210. The connection management circuitry 210 includes hardware, software, firmware, and/or a combination thereof, that supports various functionality associated with maintaining at least one session for real-time digital signing of a virtual object, each session connecting a digital signor device and at least one digital signee device. For example, in some embodiments the connection management circuitry 210 includes hardware, software, firmware, and/or a combination thereof, that authenticates a user identity associated with a digital signee device, for example as embodying a particular digital signee. Additionally or alternatively, in some embodiments the connection management circuitry 210 includes hardware, software, firmware, and/or a combination thereof, that authenticates a user identity associated with a digital signor device, for example as embodying a particular digital signor. Additionally or alternatively, in some embodiments the connection management circuitry 210 includes hardware, software, firmware, and/or a combination thereof, that initiates a session connected with a digital signor device, at least one digital signee device, and/or at least one additional viewer device. Additionally or alternatively, in some embodiments the connection management circuitry 210 includes hardware, software, firmware, and/or a combination thereof, that maintains a signee device queue associated with a particular session. In some embodiments, connection management circuitry 210 includes a separate processor, specially configured field programmable gate array (FPGA), or a specially programmed application specific integrated circuit (ASIC).

In some embodiments, the apparatus 200 includes real-time digital signing circuitry 212. The real-time digital signing circuitry 212 includes hardware, software, firmware, and/or a combination thereof, that supports various functionality associated with performing data input for a real-time digital signing of a virtual object. For example, in some embodiments the real-time digital signing circuitry 212 includes hardware, software, firmware, and/or a combination thereof, that retrieves, receives, and/or otherwise maintains live video data from at least one digital signee device and at least one digital signor device, and/or simultaneously transmits such live video data to the other device and/or additional viewer device(s). Additionally or alternatively, in some embodiments, the real-time digital signing circuitry 212 includes hardware, software, firmware, and/or a combination thereof, that receives a virtual object for real-time digital signing. Additionally or alternatively, in some embodiments, the real-time digital signing circuitry 212 includes hardware, software, firmware, and/or a combination thereof, that receives and maintains digital signature tracking data embodying a digital signature. Additionally or alternatively, in some embodiments, the real-time digital signing circuitry 212 includes hardware, software, firmware, and/or a combination thereof, that transmits and/or otherwise causes simultaneously display of the digital signature tracking data at one or more digital signee device(s) and/or any number of additional viewer device(s). Additionally or alternatively, in some embodiments, the real-time digital signing circuitry 212 includes hardware, software, firmware, and/or a combination thereof, that enables manipulation of portion(s) of digital signature tracking data and/or the digital signature. In some embodiments, real-time digital signing circuitry 212 includes a separate processor, specially configured field programmable gate array (FPGA), or a specially programmed application specific integrated circuit (ASIC).

In some embodiments, the apparatus 200 includes token generation and management circuitry 214. The token generation and management circuitry 214 includes software, hardware, firmware, and/or a combination thereof, that supports various functionality associated with a generation of a non-fungible token embodying a virtual object modified via, or otherwise linked to, a particular digital signature. For example, in some embodiments, the token generation and management circuitry 214 includes hardware, software, firmware, and/or a combination thereof, that generates data embodying a virtual object modified by superimposing a digital signature upon the virtual object at a particular position. Additionally or alternatively, in some embodiments, the token generation and management circuitry 214 includes software, hardware, firmware, and/or a combination thereof, that creates, generates, and/or otherwise mints a token, such as an NFT or other digital asset, embodying the virtual object modified with or otherwise linked to the digital signature. Additionally or alternatively, in some embodiments, the token generation and management circuitry 214 includes software, hardware, firmware, and/or a combination thereof, that links the token, such as the NFT, with a particular signee identifier, for example associated with a digital signee and/or digital signee device that was actively connected to the session and participating in the digital signing at the time that the digital signature was inputted. Additionally or alternatively, in some embodiments, the token generation and management circuitry 214 includes software, hardware, firmware, and/or a combination thereof, that provides authentication-based access associated with a particular token, such as an NFT. In some embodiments, the token-generation and management circuitry 214 includes a separate processor, specially configured field programmable gate array (FPGA), or a specially programmed application specific integrated circuit (ASIC).

Additionally or alternatively, in some embodiments, two or more of the sets of circuitries 202-214 are combinable. Alternatively or additionally, in some embodiments, one or more of the sets of circuitry perform some or all of the functionality described associated with another component. For example, in some embodiments, two or more of the sets of circuitry 202-214 are combined into a single module embodied in hardware, software, firmware, and/or a combination thereof. Similarly, in some embodiments, one or more of the sets of circuitry, for example the connection management circuitry 210, real-time digital signing circuitry 212, and/or token generation and management circuitry 214, is/are combined with the processor 202, such that the processor 202 performs one or more of the operations described above with respect to each of these sets of circuitry 210-214.

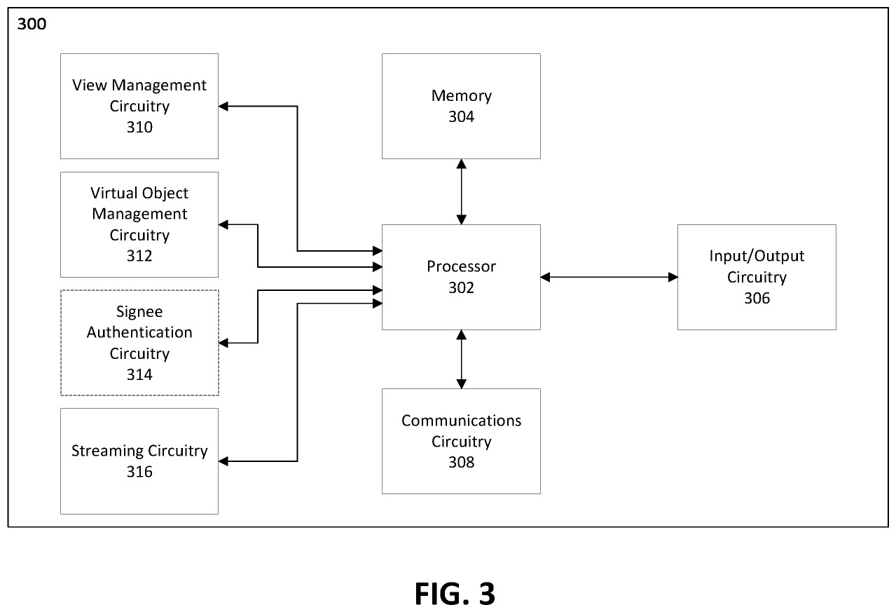

FIG. 3 illustrates a block diagram of an example real-time signee apparatus that may be specially configured in accordance with an example embodiment of the present disclosure. Specifically, FIG. 3 illustrates an example improved real-time signee apparatus 300 (“apparatus 300”) specially configured in accordance with at least one example embodiment of the present disclosure. In some embodiments, a user device embodying a digital signee device, for example any one of the user devices 104A-104N, is embodied by one or more system(s), device(s), and/or the like, such as the apparatus 300 as depicted and described in FIG. 3. The apparatus 300 includes processor 302, memory 304, input/output circuitry 306, communications circuitry 308, view management circuitry 310, virtual object management circuitry 312, signee authentication circuitry 314, and streamlining circuitry 316. In some embodiments, the apparatus 300 is configured, using one or more of the sets of circuitry 302, 304, 306, 308, 310, 312, 314, and/or 316, to execute and perform one or more of the operations described herein.

In some embodiments, the circuitry 302-308 functions similarly or identically to the similarly named sets of circuitry 202-208 as depicted and described with respect to the apparatus 200 in FIG. 2. Additionally or alternatively, in some embodiments, the processor 302 includes hardware, software, firmware, and/or a combination thereof, that supports functionality performed by a digital signee during a real-time digital signing process as described herein. For purposes of brevity, repeated disclosure with respect to the functionality of such similarly-named sets of circuitry is omitted herein.

In some embodiments, the apparatus 300 includes view management circuitry 310. The view management circuitry 310 includes software, hardware, firmware, and/or a combination thereof, that supports various functionality associated with maintaining and/or causing displaying of a digital signee interface during a real-time digital signing process. For example, in some embodiments, the view management circuitry 310 includes hardware, software, firmware, and/or a combination thereof, that facilitates real-time displaying of one or more portion(s) of live video data, displaying of a virtual object, displaying of digital signature tracking data, displaying of live chat data, and/or the like. Additionally or alternatively, in some embodiments, the view management circuitry 310 includes hardware, software, firmware, and/or a combination thereof, that communicates with a real-time digital signing system, for example embodied by the apparatus 200, to facilitate communication of data from the real-time digital signing system and/or a digital signor device for real-time displaying. Additionally or alternatively, in some embodiments, the view management circuitry 310 includes hardware, software, firmware, and/or a combination thereof, that enables local engagement with an interface rendered via the apparatus 300, for example to zoom one or more sub-interfaces, move one or more sub-interfaces, hide and/or show one or more interfaces, and/or the like. In some embodiments, the view management circuitry 310 includes a separate processor, specially configured field programmable gate array (FPGA), or a specially programmed application specific integrated circuit (ASIC).

In some embodiments, the apparatus 300 includes virtual object management circuitry 312. The virtual object management circuitry 312 includes hardware, software, firmware, and/or a combination thereof, that supports various functionality associated with retrieval and/or maintenance of a virtual object for real-time digital signing. For example, in some embodiments, the virtual object management circuitry 312 includes hardware, software, firmware, and/or a combination thereof, that enables uploading of a virtual object selected for real-time digital signing. Additionally or alternatively, in some embodiments, the virtual object management circuitry 312 includes hardware, software, firmware, and/or a combination thereof, that receives a virtual object uploaded via a digital signor device. Additionally or alternatively, in some embodiments, the virtual object management circuitry 312 includes hardware, software, firmware, and/or a combination thereof, that receives a virtual object generated or retrieved via a real-time digital signing system. Additionally or alternatively, in some embodiments, the virtual object management circuitry 312 includes hardware, software, firmware, and/or a combination thereof, that receives and/or displays digital signature tracking data associated with a virtual object. In some embodiments, the virtual object management circuitry 312 includes a separate processor, specially configured field programmable gate array (FPGA), or a specially programmed application specific integrated circuit (ASIC).

In some embodiments, the apparatus 300 includes optional signee authentication circuitry 314. In some embodiments, the use of the apparatus 300 is associated with a particular digital signee, such that subsequent authentication is not required. The signee authentication circuitry 314 includes hardware, software, firmware, and/or a combination thereof, that supports various functionality associated with authenticating a user identity associated with a particular digital signee. For example, in some embodiments, the signee authentication circuitry 314 includes hardware, software, firmware, and/or a combination thereof, that receives authentication credentials associated with an asserted user identity. Additionally or alternatively, in some embodiments, the signee authentication circuitry 314 includes hardware, software, firmware, and/or a combination thereof, that validates such authentication credentials as associated with a particular existing user identity. Additionally or alternatively, in some embodiments, the signee authentication circuitry 314 includes hardware, software, firmware, and/or a combination thereof, that authenticates one or more social media accounts as associated with a particular asserted user identity and/or user account authenticated via authentication credentials. Additionally or alternatively, in some embodiments, the signee authentication circuitry 314 includes hardware, software, firmware, and/or a combination thereof, that initiates an authenticated session associated with a particular user identity as a digital signee. Additionally or alternatively, in some embodiments, the signee authentication circuitry 314 includes hardware, software, firmware, and/or a combination thereof, that authenticates digital asset(s), token(s), NFT(s), and/or other blockchain data associated with a private key, use identity, or other particular signee identifier. In some embodiments, the signee authentication circuitry 314 includes a separate processor, specially configured field programmable gate array (FPGA), or a specially programmed application specific integrated circuit (ASIC).

In some embodiments, the apparatus 300 includes streaming circuitry 316. The streaming circuitry 316 includes hardware, software, firmware, and/or a combination thereof, that supports various functionality associated with real-time streaming of data between at least a digital signor device and the apparatus 300, for example facilitated at least in part via a real-time digital signing system. For example, in some embodiments, the streaming circuitry 316 includes one or more integrated webcam(s), peripheral camera(s), and/or the like that captures a video portion of live video data. Additionally or alternatively, in some embodiments, one or more integrated microphone(s), peripheral microphone(s), audio input device(s), and/or the like that capture an audio portion of live video data. Additionally or alternatively, in some embodiments, the streaming circuitry 316 includes hardware, software, firmware, and/or a combination thereof, that facilitates captured live video data for display via a corresponding digital signor device. Additionally or alternatively, in some embodiments, the streaming circuitry 316 includes hardware, software, firmware, and/or a combination thereof, that receives live video data from a digital signor device for real-time displaying. Additionally or alternatively, in some embodiments, the streaming circuitry 316 includes hardware, software, firmware, and/or a combination thereof, that processes and displays real-time digital signature tracking data updates, chat log updates, live video data updates, and/or uploaded virtual object updates. It will be appreciated that different implementations of the apparatus 300 may include different streaming capabilities. For example, a particular implementation may not include transmission of a video portion of live video data, such as in a circumstance where the apparatus 300 does not include or is not communicatively coupled with a camera. In some embodiments, the streaming circuitry 316 includes a separate processor, specially configured field programmable gate array (FPGA), or a specially programmed application specific integrated circuit (ASIC).

Additionally or alternatively, in some embodiments, two or more of the sets of circuitries 302-316 are combinable. Alternatively or additionally, in some embodiments, one or more of the sets of circuitry perform some or all of the functionality described associated with another component. For example, in some embodiments, two or more of the sets of circuitry 302-316 are combined into a single module embodied in hardware, software, firmware, and/or a combination thereof. Similarly, in some embodiments, one or more of the sets of circuitry, for example the view management circuitry 310, the virtual object management circuitry 312, the signee authentication circuitry 314, and the streaming circuitry 316, is/are combined with the processor 302, such that the processor 302 performs one or more of the operations described above with respect to each of these sets of circuitry 310-316.

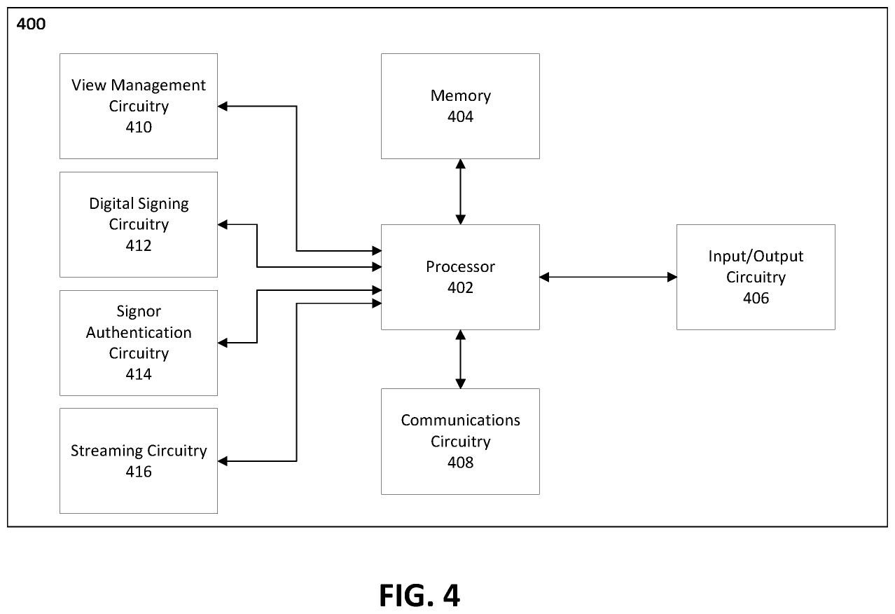

FIG. 4 illustrates a block diagram of an example real-time signor apparatus that may be specially configured in accordance with an example embodiment of the present disclosure. Specifically, FIG. 4 illustrates an example improved real-time signor apparatus 400 (“apparatus 400”) specially configured in accordance with at least one example embodiment of the present disclosure. In some embodiments, a user device embodying a digital signor device, for example the user device 106, is embodied by one or more system(s), device(s), and/or the like, such as the apparatus 400 as depicted and described in FIG. 4. The apparatus 400 includes processor 402, memory 404, input/output circuitry 406, communications circuitry 408, view management circuitry 410, digital signing circuitry 412, signor authentication circuitry 414, and streaming circuitry 416. In some embodiments, the apparatus 400 is configured, using one or more of the sets of circuitry 402, 404, 406, 408, 410, 412, 414, and/or 416, to execute and perform one or more of the operations described herein.

In some embodiments, the circuitry 402-408 functions similarly or identically to the similarly named sets of circuitry 302-308 as depicted and described with respect to the apparatus 300 in FIG. 3. Additionally or alternatively, in some embodiments, the processor 402 includes hardware, software, firmware, and/or a combination thereof, that supports functionality performed by a digital signor during a real-time digital signing process as described herein. For purposes of brevity, repeated disclosure with respect to the functionality of such similarly-named sets of circuitry is omitted herein.

In some embodiments, the apparatus 400 includes view management circuitry 410. The view management circuitry 410 includes software, hardware, firmware, and/or a combination thereof, that supports various functionality associated with maintaining and/or causing displaying of a digital signor interface during a real-time digital signing process. For example, in some embodiments, the view management circuitry 410 includes hardware, software, firmware, and/or a combination thereof, that facilitates real-time displaying of one or more portion(s) of live video data, displaying of a virtual object, displaying of digital signature tracking data inputted via the apparatus 400, displaying of live chat data, and/or the like. Additionally or alternatively, in some embodiments, the view management circuitry 410 includes hardware, software, firmware, and/or a combination thereof, that communicates with a real-time digital signing system, for example embodied by the apparatus 200, to facilitate communication of data from the real-time digital signing system and/or a digital signee device for real-time displaying. Additionally or alternatively, in some embodiments, the view management circuitry 410 includes hardware, software, firmware, and/or a combination thereof, that enables local engagement with an interface rendered via the apparatus 400, for example to zoom one or more sub-interfaces, move one or more sub-interfaces, hide and/or show one or more interfaces, and/or the like. In some embodiments, the view management circuitry 410 includes a separate processor, specially configured field programmable gate array (FPGA), or a specially programmed application specific integrated circuit (ASIC).

In some embodiments, the apparatus 400 includes digital signing circuitry 412. The digital signing circuitry 412 includes hardware, software, firmware, and/or a combination thereof, that supports various functionality associated with performing a real-time digital signing. For example, in some embodiments, the digital signing circuitry 412 includes hardware, software, firmware, and/or a combination thereof, that initiates a session associated with a particular digital signor, which is joinable by at least one digital signee and/or one or more additional viewer device(s). Additionally or alternatively, in some embodiments, the digital signing circuitry 412 includes hardware, software, firmware, and/or a combination thereof, that receives user input representing digital signature tracking data associated with particular position data relative to a virtual object. Additionally or alternatively, in some embodiments, the digital signing circuitry 412 includes hardware, software, firmware, and/or a combination thereof, that enables upload of a virtual object. Additionally or alternatively, in some embodiments, the digital signing circuitry 412 includes hardware, software, firmware, and/or a combination thereof, that enables manipulation of a digital signature. Additionally or alternatively, in some embodiments, the digital signing circuitry 412 includes hardware, software, firmware, and/or a combination thereof, that enables submission of a completed digital signature for modifying or otherwise linking to a virtual object, and/or for generation of a corresponding digital asset, token, NFT, and/or the like. In some embodiments, the digital signing circuitry 412 includes a separate processor, specially configured field programmable gate array (FPGA), or a specially programmed application specific integrated circuit (ASIC).

In some embodiments, the apparatus 400 includes optional signor authentication circuitry 414. In some embodiments, the use of the apparatus 400 is associated with a particular digital signor, such that subsequent authentication is not required. The signor authentication circuitry 414 includes hardware, software, firmware, and/or a combination thereof, that supports various functionality associated with authenticating a user identity associated with a particular digital signor. For example, in some embodiments, the signor authentication circuitry 414 includes hardware, software, firmware, and/or a combination thereof, that receives authentication credentials associated with an asserted user identity. Additionally or alternatively, in some embodiments, the signor authentication circuitry 414 includes hardware, software, firmware, and/or a combination thereof, that validates such authentication credentials as associated with a particular existing user identity. Additionally or alternatively, in some embodiments, the signor authentication circuitry 414 includes hardware, software, firmware, and/or a combination thereof, that authenticates one or more social media accounts as associated with a particular asserted user identity and/or user account authenticated via authentication credentials. Additionally or alternatively, in some embodiments, the signor authentication circuitry 414 includes hardware, software, firmware, and/or a combination thereof, that initiates an authenticated session associated with a particular user identity as a digital signor. In some embodiments, the signor authentication circuitry 414 includes a separate processor, specially configured field programmable gate array (FPGA), or a specially programmed application specific integrated circuit (ASIC).

In some embodiments, the apparatus 400 includes streaming circuitry 416. The streaming circuitry 416 includes hardware, software, firmware, and/or a combination thereof, that supports various functionality associated with real-time streaming of data between at least a digital signee device and the apparatus 400, for example facilitated at least in part via a real-time digital signing system. For example, in some embodiments, the streaming circuitry 416 includes one or more integrated webcam(s), peripheral camera(s), and/or the like that captures a video portion of live video data. Additionally or alternatively, in some embodiments, one or more integrated microphone(s), peripheral microphone(s), audio input device(s), and/or the like that capture an audio portion of live video data. Additionally or alternatively, in some embodiments, the streaming circuitry 416 includes hardware, software, firmware, and/or a combination thereof, that facilitates captured live video data for display via a corresponding digital signor device. Additionally or alternatively, in some embodiments, the streaming circuitry 416 includes hardware, software, firmware, and/or a combination thereof, that receives live video data from a digital signee device for real-time displaying. Additionally or alternatively, in some embodiments, the streaming circuitry 416 includes hardware, software, firmware, and/or a combination thereof, that processes and displays real-time digital signature tracking data updates, chat log updates, live video data updates, and/or uploaded virtual object updates. It will be appreciated that different implementations of the apparatus 400 may include different streaming capabilities. For example, a particular implementation may not include transmission of a video portion of live video data, such as in a circumstance where the apparatus 400 does not include or is not communicatively coupled with a camera. In some embodiments, the streaming circuitry 416 includes a separate processor, specially configured field programmable gate array (FPGA), or a specially programmed application specific integrated circuit (ASIC).

Additionally or alternatively, in some embodiments, two or more of the sets of circuitries 402-416 are combinable. Alternatively or additionally, in some embodiments, one or more of the sets of circuitry perform some or all of the functionality described associated with another component. For example, in some embodiments, two or more of the sets of circuitry 402-416 are combined into a single module embodied in hardware, software, firmware, and/or a combination thereof. Similarly, in some embodiments, one or more of the sets of circuitry, for example the view management circuitry 410, the digital signing circuitry 412, the signor authentication circuitry 414, and the streaming circuitry 416, is/are combined with the processor 402, such that the processor 402 performs one or more of the operations described above with respect to each of these sets of circuitry 410-416.

### Exemplary Data Flows

Having described example systems and apparatuses in accordance with the present disclosure, example data flows in accordance with the present disclosure will now be discussed. In some embodiments, the data flows are performed by a real-time digital signing system, for example embodied by the apparatus 200, in communication with at least one digital signee device, for example embodied by the apparatus 300, and a digital signor device, for example embodied by the apparatus 400. In some embodiments, the apparatus 200 maintains a session that facilitates a connection between the digital signor device and the digital signee device enabling the data flows as depicted and described herein.

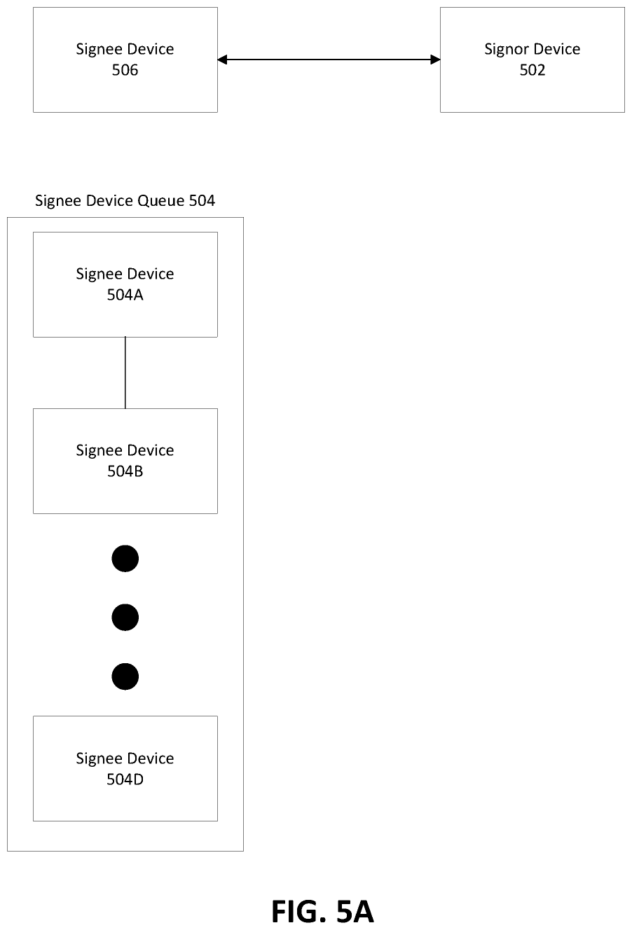

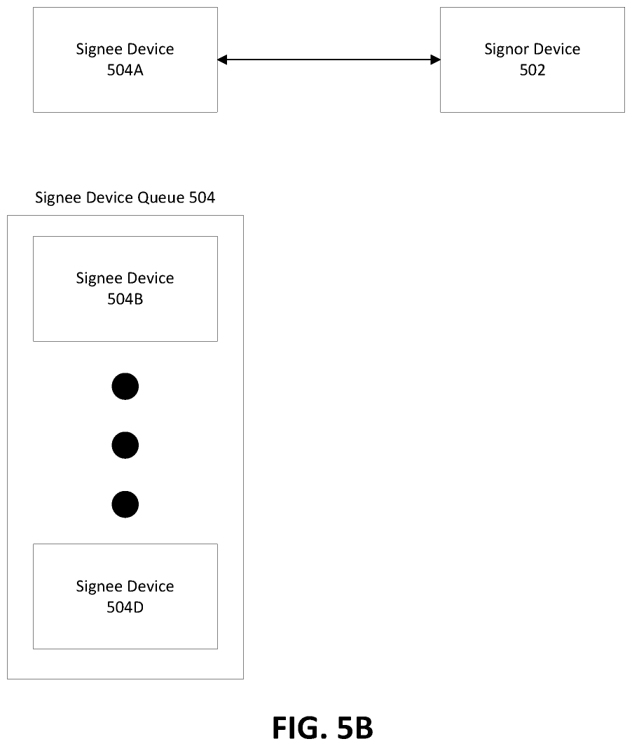

FIGS. 5A and 5B illustrates a data flow between example devices associated with management of a signee device queue in accordance with at least one example embodiment of the present disclosure. Specifically, FIGS. 5A and 5B illustrate a data flow for managing a signee device queue during a particular session, for example that facilitates a real-time digital signing process between a particular signor device 502 and a particular signee device. In some embodiments, the signee device embodies a particular digital signee device currently connected to the session to take part in a real-time digital signing process. In this regard, in some such embodiments, the session may facilitates only a single digital signee device to take part in a real-time digital signing process at a time.

As illustrated, the data flow includes a device signee queue 504. In some embodiments, the device signee queue 504 is maintained associated with a particular session, for example for connection with a particular digital signor device 502, during a real-time digital signing process. In some such embodiments, the apparatus 200 maintains the device signee queue 504 for each particular session. In this regard, a different signee device queue may be maintained for each session maintained by the apparatus 200, such as associated with each different digital signor device for which a session is currently active.

The signee device queue 504 may include any number of digital signee devices (e.g., “signee devices”), for example the signee devices 504A-504N. In some embodiments, the signee device queue 504 embodies an ordered list of signee devices. In this regard, a signee device may provide particular input to join the signee device queue 504 in the next available position. For example, as illustrated in FIG. 5A, the signee device queue 504 includes a signee device 504A in a first position within the ordered list embodied by the signee device queue 504, with signee device 504B in a second position within the ordered list, and so on until the final signee device 504N positioned last in the ordered list. In this regard, a newly queued signee device may enter the signee device queue 504 at a position subsequent in order to the signee device 504N.

In some embodiments, the signee device queue 504 is maintained as an array arranged in a particular order. In other embodiments, the signee device queue 504 is maintained as a linked list connected in a particular order. It will be appreciated that in other embodiments, another data structure may be utilized.

In some embodiments, a digital signee device submits a bid to join the signee device queue 504. For example, in some embodiments, a particular digital signee device bids a particular amount of electronic currency (e.g., representing a particular fiat currency, cryptocurrency amount, and/or the like), such that digital signee devices are arranged in the signee device queue 504 based on the value of their bid. In some such embodiments, a digital signee device that bids higher than another digital signee device may be positioned at an earlier position in the signee device queue.

At any given time, a session may connect the signor device 502 with a particular signee device for participating in a real-time digital signing process. As illustrated in FIG. 5A, the signor device 502 is connected within the session to the signee device 506. In this regard, the signee device 506 may be the only digital signee device to actively take part in the real-time digital signing process with the signor device 502 at the time. For example, the signee device 506 may be enabled to upload a particular virtual object for digital signing by the signor device 502. Additionally or alternatively, in some embodiments, real-time live video data is captured and transmitted for display at the signor device 502 interacting with the signee device 506. Additionally or alternatively, in some embodiments, any digital asset, token, NFT, or the like generated during or as a result of the digital signing process performed via the signee device 506 and signor device 502 may be assigned to a particular signee identifier corresponding to or otherwise associated with the signee device 506.

In some embodiments, the signor device 502 may perform a real-time digital signing process of a virtual object without any particular digital signee device being connected. For example, in some embodiments, the signor device 502 performs a real-time digital signing process of a virtual object uploaded by the signor device 502 and/or generated automatically by a system, for example selected by the apparatus 200 maintaining a session between the signor device 502 and any number of candidate digital signee device(s) and/or additional viewer device(s). In some such embodiments, each candidate digital signee device may submit a particular bid for a digital asset resulting from the real-time digital signing process. For example, each candidate digital signee device may submit a bid representing a particular amount of electronic currency value in exchange for a token representing the virtual object signed with and/or otherwise linked to the digital signature provided by the signor device 502. In this regard, upon triggering of a data-driven event (e.g., end of a bidding timer, user input via the digital signor device 502, and/or the like), the digital signee device associated with the highest bid in some embodiments is connected to the session as the current digital signee device, such that this digital signee device receives the corresponding virtual object digitally signed via the inputted digital signature tracking data, for example embodied by a token, NFT, and/or the like as described herein. In this regard, digital signee devices may bid to obtain one or more virtual object(s) digitally signed via the digital signor device during that session.

The real-time digital signing process of a virtual object may be facilitated via the session connecting the signee device 506 and the signor device 502 until one or more triggering condition(s) is/are met. For example, in some embodiments, the signor device 502 may provide a signal terminating connection with the signee device 506. In other embodiments, the session connects the signee device 506 and the signor device 502 until a digital signature associated with a virtual object is submitted via the signor device 502. Additionally or alternatively, in some embodiments, the session connects the signee device 506 and the signor device 502 until the signee device 506 disconnects from the session or signals completion of the real-time digital signing process. In this regard, it will be appreciated that the signee device 506 may be indicated or otherwise determines as a current digital signee device while it is connected via the session for taking part in a real-time digital signing process with the signor device 502.

In some embodiments, upon termination of connection with a current digital signee device for participating in the real-time digital signing process, the session may subsequently connect a next device from the signee device queue 504. For example, in some embodiments, the apparatus 200 pops the next device from the first ordered position in the signee device queue 504, and connects that next device as the current digital signee device for taking part in a real-time digital signing process. As illustrated in FIG. 5B, for example, the signee device 504A is identified as the next device in the signee device queue 504, and assigned as the current signee device. In this regard, the signee device 504A may interact with the signor device 502 to take part in a real-time digital signing process. It will be appreciated such a cycle may continue for any number of times, for example until the signee device queue 504 is empty, until a certain length of time elapses, and/or until another data-driven trigger is satisfied.

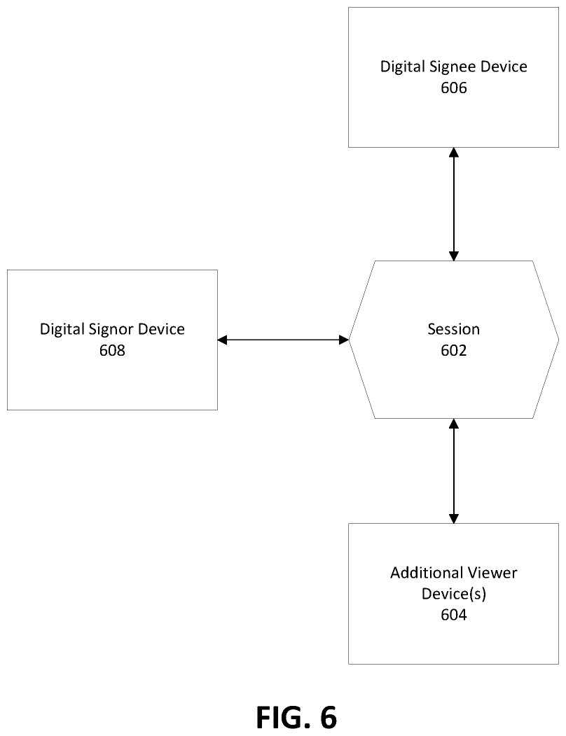

FIG. 6 illustrates a visualization of device connectivity during real-time signing of a virtual object in accordance with at least one example embodiment of the present disclosure. Specifically, FIG. 6 illustrates a digital signee device 606, digital signor device 608, and additional viewer device(s) 604 that are each connected to a session 602. In some embodiments, the session 602 is maintained by a particular real-time digital signing system, for example embodied by the apparatus 200, to facilitate a real-time digital signing of a virtual object.

In some embodiments, the digital signee device 606 communicates with the session 602 to transmit a particular virtual object for signing. In some embodiments, the digital signee device 606 uploads the virtual object from a memory or other datastore accessible to the digital signee device 606. In response to upload of the virtual object, the virtual object may be rendered and/or otherwise depicted in real-time at each of the digital signee device 606, the digital signor device 608, and/or each of the additional viewer device(s) 604.

In some embodiments, the digital signor device 608 communicates with the session 602 to provide input embodying a digital signature associated with the virtual object. For example, in some embodiments, the digital signor device 608 inputs, in response to user engagement, digital signature tracking data associated with particular position data relative to the virtual object (e.g., embodying a virtual pen stroke at a particular position on a coordinate system defined by or otherwise associated with the virtual object). In this regard, the virtual pen stroke embodied by the digital signature tracking data may be rendered using particular visual marks at the particular position. In some embodiments, the digital signature tracking data embodies virtual pen strokes on a digital whiteboard canvas layered on top of the virtual object, such that the digital signature is superimposed on top of the underlying uploaded virtual object. In some embodiments, in response to input of the digital signature tracking data, such digital signature tracking data is rendered in real-time via an interface to each of the digital signor device 608, digital signee device 606, and each of the additional viewer device(s) 604.

In some embodiments, the digital signor device 608 and the digital signee device 606 each capture and/or transmit particular data associated with or otherwise depicting the user during the real-time digital signing process. For example, in some embodiments, the digital signee device 606 captures live video data embodying video and/or audio of the user of the digital signee device 606 during the signing, which is relayed to the session 602 and to the digital signor device 608 and/or each of the additional viewer device(s) 604. Additionally or alternatively, in some embodiments, the digital signor device 608 captures live video data embodying video and/or audio of the user of the digital signor device 608 during the signing, which is relayed to the session 602 and to the digital signee device 606 and/or each of the additional viewer device(s) 604.

Such a process may proceed until any of a myriad of data-driven triggers is/are satisfied. In some embodiments, the digital signor device 608 may continue to provide digital signature tracking data until indicating completion of a digital signature. Upon completion of the digital signature, the session 602 may permanently modify the virtual object with the digital signature, and/or otherwise link the completed digital signature to the virtual object. Additionally or alternatively, in some embodiments, the session 602 may initiate near-real-time generation of a digital asset, a token, or an NFT based at least in part on or otherwise embodying the virtual object modified with or otherwise linked to the digital signature. Subsequently, in some embodiments, a new digital signee device may be connected to the session 602 as a currently active digital signee device, for example from a signee device queue associated with the session 602.

In some embodiments, the additional viewer device(s) 604 each embody passive onlookers to the real-time digital signing process. In this regard, each additional viewer device may render a user interface depicting the live video data from the digital signee device 606 and/or the digital signor device 608, depict the uploaded virtual object, depict the digital signature tracking data, and/or the like, as it is updated during the real-time digital signing process. However, the additional viewer device(s) 604 in some such embodiments do not take part in the real-time digital signing process. In some embodiments, the session 602 maintains a chat log or other form of engagement that the additional viewer device(s) 604 may participate in separate to the upload and signing steps of the real-time digital signing process.

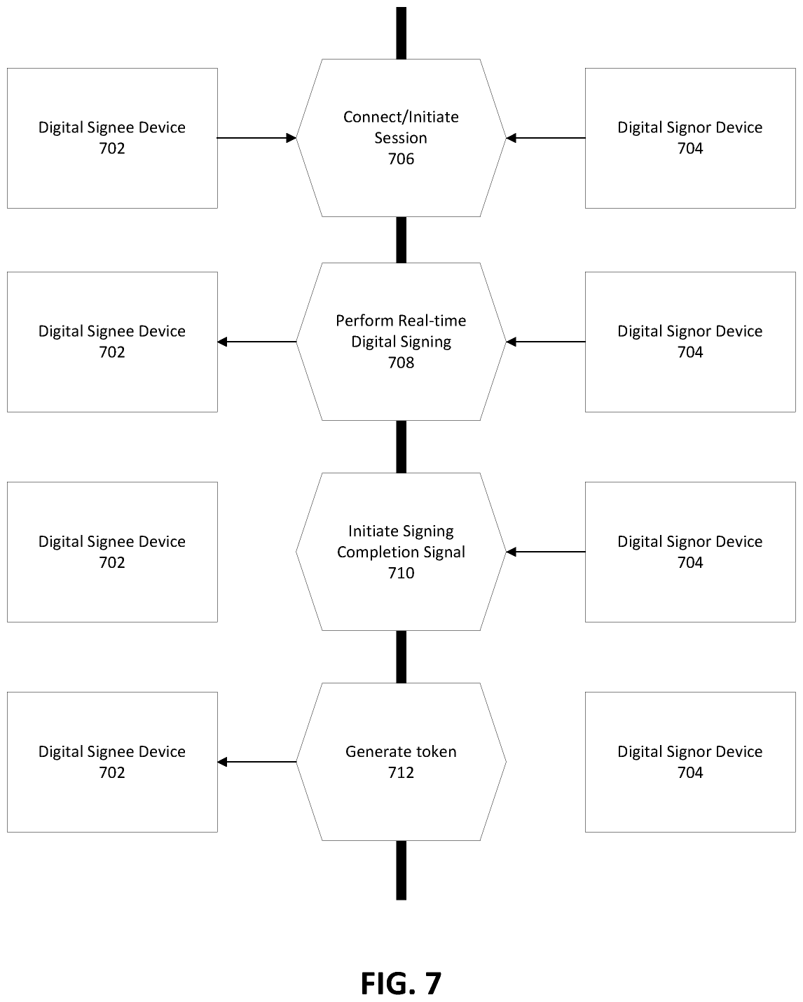

FIG. 7 illustrates a sequence diagram of operations performed during real-time signing of a virtual object in accordance with at least one example embodiment of the present disclosure. Specifically, FIG. 7 illustrates steps of an example data flow for a single iteration of a real-time digital signing process between a digital signee device 702 and a digital signor device 704. It will be appreciated that, in some embodiments, the data flow is repeated for any number of real-time digital signing processes, for example associated with multiple digital signee devices one-at-a-time from a signee device queue. In some embodiments, the steps are performed by the apparatus 200 in communication with the digital signee device 702 embodied by the apparatus 300, and the digital signor device 704 embodied by the apparatus 400.

As illustrated, at step 706 the digital signee device 702 and the digital signor device 704 each connect to and/or initiates a session. In some embodiments, the digital signor device 704 initiates a session that is then searchable by one or more digital signee devices. A digital signee device, such as the digital signee device 702, may subsequently connect to the session to participate in a real-time digital signing process with the digital signor device 704, and/or queue to take part in such a real-time digital signing process.

As illustrated, at step 708 the digital signee device 702 and the digital signor device 704 perform the real-time digital signing. In some embodiments, one of the digital signee device 702 or the digital signor device uploads a virtual object for signing. Subsequently, the digital signor device 704 may provide input representing digital signature tracking data. The digital signor device 704 may continue to provide such input until the digital signature is completed.

In some embodiments, the apparatus 200 performs one or more authentication algorithm(s) that verifies the authenticity of the digital signor, the digital signature tracking data, the actions performed during the real-time digital signing session, and/or the like. For example, in some embodiments, the apparatus 200 tracks timestamps associated with each action, input, and/or the like performed by a digital signor during the real-time digital signing session. For example, in some embodiments the apparatus 200 tracks a timestamp corresponding to input of digital signature tracking data, movement of digital signature tracking data, erasing of digital signature tracking data, and/or the like. In some such embodiments, the apparatus 200 processes live video data associated with the digital signor device, for example using computer vision model(s), machine learning model(s), AI model(s), and/or other image processing algorithm(s), to detect actions performed by the digital signor and confirm such actions correspond to input of the digital signature tracking data. In this regard, it will be appreciated that live video data may similarly be captured associated with particular timestamp(s), such that comparison between the timestamp(s) of live video data for the digital signor device and action(s) performed via the digital signor device and/or transmitted to the apparatus 200 may be compared.

Alternatively or additionally, in some embodiments, any of a number of authentication algorithm(s) may be initiated. For example, in some embodiments, the apparatus 200 performs computer vision, ML, AI, and/or image processing to perform facial recognition or other identity recognition of the digital signor from live video data captured via the digital signor device. Additionally or alternatively, in some embodiments, the apparatus 200 performs signature analysis based at least in part on the digital signature tracking data submitted to the apparatus 200 as part of a live signature to compare the digital signature tracking data to validated digital signatures associated with the digital signor. In some such embodiments, the apparatus 200 may perform pen stroke analysis based at least in part on digital signature tracking data inputted via the digital signor device.

As illustrated, at step 710 the digital signor device 704 initiates a signing completion signal. In some embodiments, the signing completion signal indicates that the digital signature is complete. In some embodiments, the digital signor device 704 transmits the signing completion signal in response to user engagement with a particular user interface element, for example a “completed” or “submit” button that indicates a user has completed inputting the digital signature.

As illustrated, at step 712, the apparatus 200 for example generates a token. In some embodiments, the token is a NFT embodying the virtual object modified by or otherwise linked with the digital signature inputted via the digital signor device 704. For example, in some embodiments, the apparatus 200 generates data embodying the virtual object with the digital signature tracking data permanently superimposed at particular positions within the boundary of the virtual object. The token in some embodiments is generated via a blockchain, for example by creating, generating, and/or minting the NFT as the token utilizing a particular protocol. In some embodiments, the generated token is linked to the digital signee device 702, and/or the user thereof. For example, in some embodiments, the apparatus 200 links the generated token with a signee identifier representing the digital signee device 702, an authenticated user identity or account associated with the digital signee device 702, and/or that is otherwise inputted via the digital signee device 702. In this regard, the user of the digital signee device 702 may have access to the signee identifier to authenticate themselves as the owner associated with the generated token.

### Exemplary Interfaces

Having described example systems, apparatuses, and data flows in accordance with the present disclosure, example user interfaces in accordance with the present disclosure will now be discussed. In some embodiments, the user interfaces are renderable via one or more computing system(s), device(s), and/or the like in real-time or near-real-time. The user interfaces may be engaged by a particular user to participate in a real-time digital signing process.

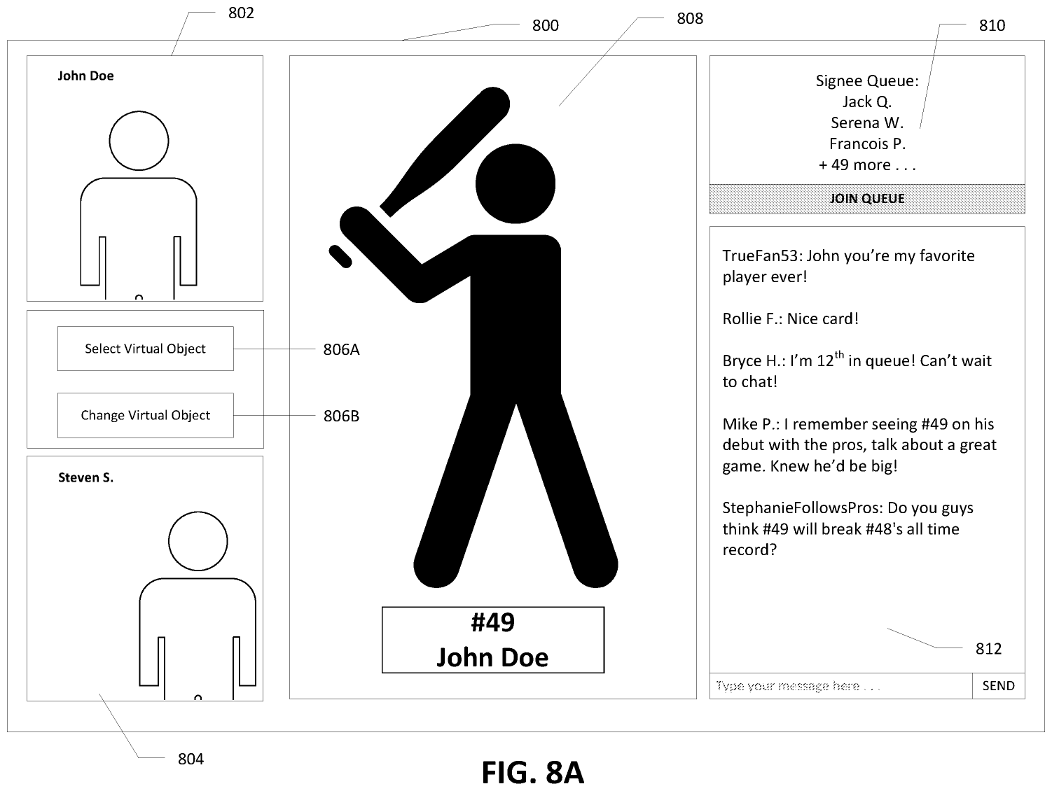

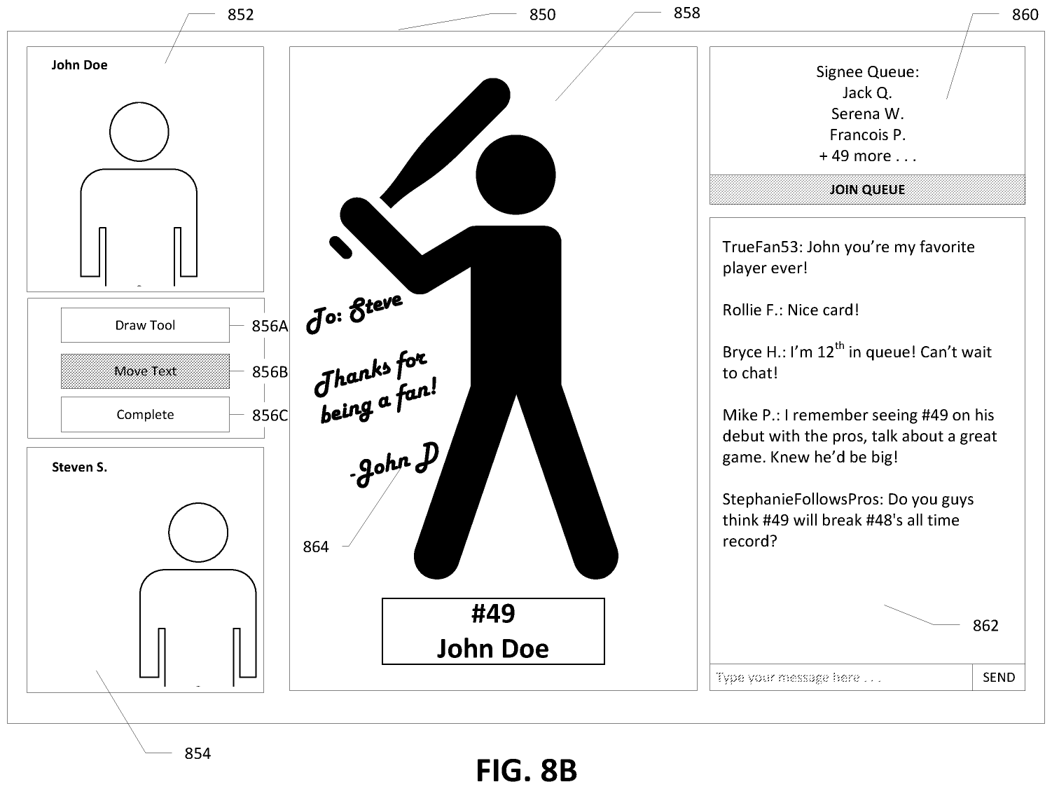

FIG. 8A illustrates an example signee interface in accordance with at least one example embodiment of the present disclosure. Specifically, FIG. 8A illustrates an example signee interface 800. In some embodiments, the signee interface 800 is rendered via a digital signee device, for example embodied by the apparatus 300 as depicted and described herein.

As illustrated, the signee interface 800 includes a signor live video stream sub-interface 802. In some embodiments, the signor live video stream sub-interface 802 depicts live video data captured and transmitted via the digital signor device associated with the real-time digital signing session. Additionally, as illustrated, the signee interface 800 includes a signee live video stream sub-interface 804. In some embodiments, the signee live video stream sub-interface 804 depicts live video data captured and transmitted via the digital signee device associated with the real-time digital signing session. In this regard, using the sub-interfaces 802 and 804, the users may see each other and/or interact via video during the real-time digital signing process.

In some embodiments, the signee interface 800 includes one or more control(s) for uploading a virtual object for digital signing. As illustrated, the signee interface 800 includes a select virtual object button 806A that enables selection of a virtual object for digital signing from a memory, database, and/or the like accessible to the apparatus 300. Additionally or alternatively, in some embodiments, the signee interface 800 includes a second interface element for changing the virtual object once selected. For example, as illustrated, the signee interface 800 includes a change virtual object button 806B.

The signee interface 800 includes a virtual object representation 808. As illustrated, the example virtual object as depicted may be an image of a baseball card corresponding to John Doe, who is the digital signor participating in the real-time digital signing process. The virtual object may be uploaded by the digital signee, for example via the interface elements 806A and/or 806B. It should be appreciated that, in some embodiments, the digital signee may upload any desired virtual object.

In some embodiments, the signee interface 800 optionally includes a queue status sub-interface 810. In some embodiments, the queue status sub-interface indicates whether one or more users, and/or how many users, are currently included in a signee device queue associated with the session. Additionally or alternatively, in some embodiments, the queue status sub-interface 810 includes one or more control(s) for joining the signee device queue at a current last position.

In some embodiments, the signee interface 800 optionally includes a live chat log 812. In some embodiments, the live chat log 812 includes any message(s) submitted by user(s) associated with the session. Such messages may be broadcast to each device connected to the session, including the digital signor device, the digital signee device, and/or any additional viewer devices connected to the session. Additionally or alternatively, in some embodiments, the live chat log 812 enables transmission of a new chat message for transmission to the chat log.

In some embodiments, the signee interface 800 is similarly depicted to any additional viewer device(s) connected to the session. For example, in some embodiments, each additional viewer device receives the same interface, but does not include the controls for uploading a virtual object, and sees the signee sub-interface for the current active digital signee device and not themselves. However, such an additional viewer device may join the signee device queue to become the active current digital signee device at a later time.

FIG. 8B illustrates an example signor interface in accordance with at least one example embodiment of the present disclosure. Specifically, FIG. 8B illustrates an example signor interface 850. In some embodiments, the signor interface 850 is rendered via a digital signor device, for example embodied by the apparatus 400 as depicted and described herein.

As illustrated, the signor interface 850 similarly includes a signor live video stream sub-interface 852. In some embodiments, the signor live video stream sub-interface 852 depicts live video data captured and transmitted via the digital signor device associated with the real-time digital signing session. In this regard, the user may see themselves broadcasting via the signor live video stream sub-interface 852. Additionally, as illustrated, the signor interface 850 includes a signor live video stream sub-interface 854. In some embodiments, the signor live video stream sub-interface 854 depicts live video data captured and transmitted via the digital signee device associated with the real-time digital signing session. In this regard, using the sub-interfaces 852 and 854, the users may see each other and/or interact via video during the real-time digital signing process.

In some embodiments, the signor interface 850 includes one or more control(s) for selecting a virtual object for digital signing. For example, in some embodiments the signor interface 850 includes one or more buttons or other controls for uploading a virtual object, and/or changing an uploaded virtual object. Additionally or alternatively, in some embodiments, the signor interface 850 includes one or more control(s) for inputting a digital signature. For example as illustrated, the signor interface 850 includes a draw tool control 856A. In some embodiments, selection of the draw tool control 856A enables the user to engage with the user interface to input digital signature tracking data associated with the uploaded virtual object. For example, in some embodiments, the digital signature tracking data may be superimposed on top of the uploaded virtual object, as described herein.

Additionally or alternatively, in some embodiments, the signor interface 850 includes a move text control 856B. In some embodiments, selection of the move text control 856B (e.g., by engaging the control) enables movement, reposition of, and/or other manipulation of inputted digital signature tracking data. In some embodiments, the user may move the digital signature tracking data to be associated with new position data within the boundary of the uploaded virtual object.

Additionally or alternatively, in some embodiments, the signor interface 850 includes a complete signature control 856C. In some embodiments, selection of the complete signature control 856C generates a signing completion signal transmitted to the apparatus 200. The signing completion signal may indicate completion of the digital signature associated with the virtual object. In some embodiments, the apparatus 200 for example may initiate near-real-time generation of a NFT based at least in part on the uploaded virtual object and digital signature embodied by the digital signature tracking data upon engagement with the complete signature control 856C. Additionally or alternatively, in some embodiments, engagement with the complete signature control 856C may prevent subsequent manipulation of the digital signature tracking data, and/or may prevent subsequent addition of any new digital signature tracking data.

It will be appreciated that in other embodiments the signor interface 850 includes any of a myriad of other tools for inputting and/or manipulating a digital signature. In some embodiments, the signor interface 850 includes at least one control for clearing a digital signature tracking data. Additionally or alternatively, in some embodiments, the signor interface 850 includes at least one control for erasing portion(s) of digital signature tracking data. Additionally or alternatively, in some embodiments, the signor interface 850 includes at least one control for altering properties of a virtual pen utilized to input digital signature tracking data.

The signor interface 850 includes a virtual object sub-interface 858. As illustrated, the example virtual object as depicted may be an image of a baseball card corresponding to John Doe, who is the digital signor participating in the real-time digital signing process. The virtual object may be uploaded by the digital signee, for example via the signee interface 800 as depicted and described with respect to FIG. 8A. It should be appreciated that, in some embodiments, the digital signee may upload any desired virtual object.

In some embodiments, the signor interface 850 is configured to enable interaction with the virtual object sub-interface 858 to input digital signature tracking data 864. In this regard, each input of digital signature tracking data 864 may appear in real-time as the digital signor performs such user engagement, for example via a click, touch, gesture, and/or the like. The digitals signature tracking data may embody a virtual mark or pen stroke that appears at a particular position based on the location of the user engagement, for example such that the mark appears at the position where the user touched. In this regard, the digital signor may continue to interact with the virtual object sub-interface 858 to provide one or more portion(s) of digital signature tracking data embodying a completed digital signature.

Upon input of each portion of digital signature tracking data, the corresponding portion of digital signature tracking data may, simultaneously and in real-time, be rendered to each other device connected to the session during the real-time digital signing process. For example, the digital signature tracking data may be transmitted, via the apparatus 200, to a digital signee device and rendered via the signee interface 800 in real-time. Additionally or alternatively, the digital signature tracking data may be transmitted to an additional viewer device and rendered via a corresponding interface in real-time. In this regard, each of such devices may view the digital signature tracking data being inputted via user engagement in real-time during the digital signing process.

In some embodiments, the signor interface 850 optionally includes a queue status sub-interface 860. In some embodiments, the queue status sub-interface indicates whether one or more users, and/or how many users, are currently included in a signee device queue associated with the session. Additionally or alternatively, in some embodiments, the queue status sub-interface 860 includes one or more control(s) for joining the signee device queue at a current last position. In some such embodiments, a digital signor may not join their own associated signee device queue, so such a sub-component may not be rendered.

In some embodiments, the signor interface 800 optionally includes a live chat log 862. In some embodiments, the live chat log 862 includes any message(s) submitted by user(s) associated with the session. Such messages may be broadcast to each device connected to the session, including the digital signor device, the digital signee device, and/or any additional viewer devices connected to the session. Additionally or alternatively, in some embodiments, the live chat log 862 enables transmission of a new chat message for transmission to the chat log.

It will be appreciated that the various user interfaces are updated in real-time and in conjunction with one another based on the various controls available to each user. For example, in some embodiments, both the signee interface associated with a digital signee device and the signor interface associated with a digital signor device are updated in real-time upon selection and/or uploading of a particular virtual object for signing, such that both users see a representation of the virtual object for digital signing. Similarly, in some embodiments, both the signee interface associated with a digital signee device and the signor interface associated with a digital signor device are updated in real-time upon inputting of digital signature tracking data by the digital signor, such that corresponding digital marks appear on the representations of the virtual object at the same positions and in real-time as they are inputted. The corresponding additional viewer devices may receive such real-time depicted updates without providing any user input that affects the real-time digital signing process.

### Exemplary Processes

Having described example systems and apparatuses, related data flows, data architectures, and user interfaces in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

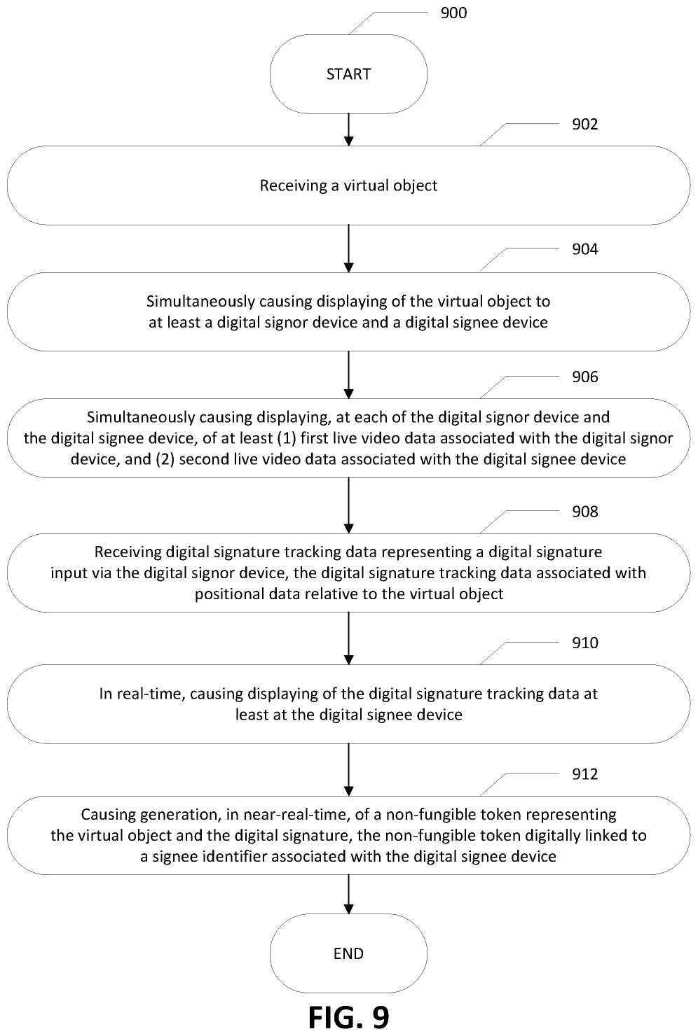

FIG. 9 illustrates a flowchart depicting operations of at least one example process for real-time digitally signing a virtual object in accordance with at least one example embodiment of the present disclosure. In some embodiments, the process 900 is embodied by computer program code stored on a non-transitory computer-readable storage medium of a computer program product configured for execution to perform the process as depicted and described. Alternatively or additionally, in some embodiments, the process 900 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with a separate digital signee device, digital signor device, viewer device, and/or the like. For purposes of simplifying the description, the process 900 is described as performed by and from the perspective of the apparatus 200.

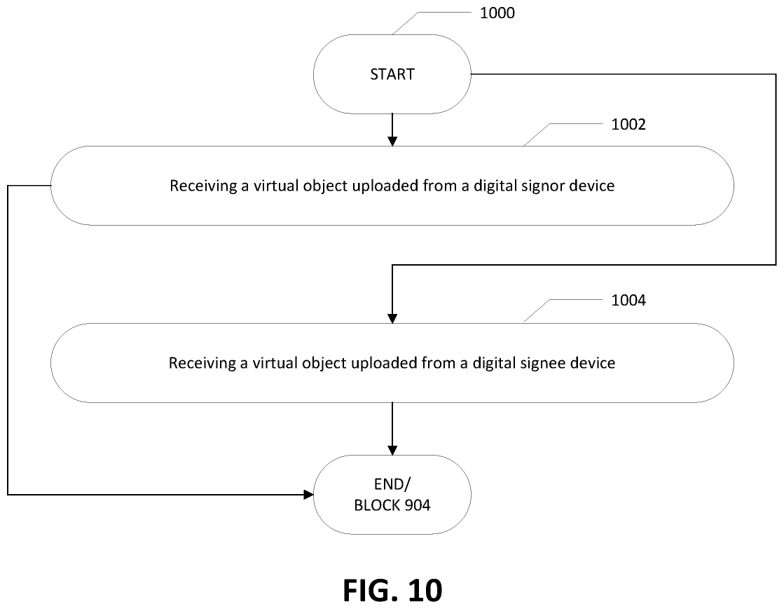

The process 900 begins at operation 902. At operation 902, the apparatus 200 includes connection management circuitry 210, real-time digital signing circuitry 212, token generation and management circuitry 214, communications circuitry 208, input/output circuitry 206, processor 202, and/or a combination thereof, that receives a virtual object. In some embodiments, the virtual object is renderable for digital signing during a session. In some embodiments, the virtual object is uploadable by one or more devices, for example as described herein with respect to FIG. 10. In other embodiments, the virtual object is predetermined for retrieval by the apparatus 200, or generated by the apparatus 200.

At operation 904, the apparatus 200 includes connection management circuitry 210, real-time digital signing circuitry 212, token generation and management circuitry 214, communications circuitry 208, input/output circuitry 206, processor 202, and/or a combination thereof, that simultaneously causes displaying of the virtual object to at least a digital signor device and a digital signee device. In some embodiments, the apparatus 200 maintains a session that includes or otherwise is associated with the virtual object, transmitting the virtual object for rendering to each of the digital signor device and the digital signee device. The virtual object may be rendered to each of the digital signor device and the digital signee device in real-time or near-real-time.

At operation 906, the apparatus 200 includes connection management circuitry 210, real-time digital signing circuitry 212, token generation and management circuitry 214, communications circuitry 208, input/output circuitry 206, processor 202, and/or a combination thereof, that simultaneously causes displaying, at each of the digital signor device and the digital signee device, of one or more portions of live video data. In some embodiments, the apparatus 200 causes simultaneous displaying of first live video data associated with the digital signor device, and second live video data associated with the digital signee device. For example, in some embodiments, the first live video data embodies live stream video data depicting the signor during the signing process, such as via an integrated webcam, video camera, or other peripheral communicatively coupled with the digital signor device. In some embodiments, the second live video data embodies live stream video data depicting the signee during the signing process, such as via an integrated webcam, video camera, or other peripheral communicatively coupled with the digital signee device. The live video data may be transmitted to the apparatus 200 from the digital signor device, or digital signee device, respectively for transmission to the other device.

At operation 908, the apparatus 200 includes connection management circuitry 210, real-time digital signing circuitry 212, token generation and management circuitry 214, communications circuitry 208, input/output circuitry 206, processor 202, and/or a combination thereof, that receives digital signature tracking data from the digital signor device. In some embodiments, the digital signature tracking data represents a digital signature input via the digital signor device. In some such embodiments, the digital signature tracking data represents touch, click, gesture, or other user engagement that represents a particular pen stroke corresponding to rendered data to a particular interface, canvas, and/or the like. For example, in some embodiments, each portion of digital signature tracking data represents different portions of rendered data within the interface, canvas, or the like, such that the combinations of portions embodies the full digital signature. In some embodiments, the input corresponding to the digital signature tracking device is transmitted to the apparatus 200 upon engagement via the digital signor device.

In some embodiments, the digital signature tracking data is associated with positional data. The positional data may be defined relative to the virtual object, for example based on the origin of the virtual object, a coordinate system defined by the virtual object, and/or the like. In this regard, the positional data may define the location to render the corresponding digital signature tracking data. In some embodiments, the positional data is updateable via manipulation of the digital signature after input.

At operation 910, the apparatus 200 includes connection management circuitry 210, real-time digital signing circuitry 212, token generation and management circuitry 214, communications circuitry 208, input/output circuitry 206, processor 202, and/or a combination thereof, that, in real-time, causes displaying of the digital signature tracking data at least at the digital signee device. In this regard, the apparatus 200 may facilitate transmission of the digital signature tracking data to the digital signee device, and/or update a shared session that causes the digital signee device to update rendering of the virtual object with digital signature tracking data. In some such embodiments, the digital signature tracking data is superimposed on top of the virtual object during rendering, for example, within the canvas or other interface utilized to render the virtual object. In some embodiments, the digital signature tracking data is rendered to the digital signor device and the digital signee device in real-time.

At operation 912, the apparatus 200 includes connection management circuitry 210, real-time digital signing circuitry 212, token generation and management circuitry 214, communications circuitry 208, input/output circuitry 206, processor 202, and/or a combination thereof, that causes generation, in near-real-time, of a digital asset, token, or a NFT representing the virtual object and the digital signature. Specifically, in some embodiments, the NFT includes the virtual object modified with the digital signature formed by one or more portions of digital signature tracking data permanently superimposed onto the virtual image (e.g., to form a single, updated image linked with the digital signature). In some embodiments, the apparatus 200 initiates one or more process(es) to create, generate, and/or otherwise mint the NFT. It will be appreciate that any of a myriad of NFT creating, generating, and/or minting procedure(s), blockchain implementation(s), and/or other protocol(s) may be utilized to generate, create, and/or mint the NFT. In some embodiments, the NFT is created utilizing an ERC-1155 compliant token and/or contract protocol, and is stored and/or otherwise maintained via IPF S.

In some embodiments, the digital asset, token, or NFT is digitally linked to a signee identifier associated with the digital signee device. In this regard, the signee identifier in some embodiments embodies a numeric, alphabetical, alphanumeric, or other data identifier that uniquely identifies the user authenticated associated with the digital signee device. In some embodiments, the signee identifier embodies a universal unique identifier that uniquely identifiers the signee on a particular blockchain. In some such embodiments, the signee identifier is utilized to generate, create, and/or mint the corresponding NFT, such that the NFT is digitally linked to the signee identifier utilizing cryptography to indicate ownership of the NFT by the corresponding signee identifier. In this regard, authentication associated with the signee identifier, or in some embodiments the signee identifier itself in circumstances where the signee identifier is intended to remain secret, may be utilized to obtain, transfer, or otherwise interact with the NFT.

FIG. 10 illustrates a flowchart depicting operations of at least one example process for receiving a virtual object, for example as a part of a process for real-time digitally signing a virtual object, in accordance with at least one example embodiment of the present disclosure. In some embodiments, the process 1000 is embodied by computer program code stored on a non-transitory computer-readable storage medium of a computer program product configured for execution to perform the process as depicted and described. Alternatively or additionally, in some embodiments, the process 1000 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with a separate digital signee device, digital signor device, viewer device, and/or the like. For purposes of simplifying the description, the process 1000 is described as performed by and from the perspective of the apparatus 200.

The process 1000 begins at one of operation 1002 or operation 1004. In some embodiments, the process 1000 begins after one or more operations depicted and/or described with respect to any one of the other processes described herein. In this regard, some or all of the process 1000 may replace or supplement one or more blocks depicted and/or described with respect to any of the processes described herein. Upon completion of the process 1000, the flow of operations may terminate. Additionally or alternatively, as depicted, upon completion of the process 1000 in some embodiments, flow may return to one or more operation(s) of another process, such as the operation 904. It will be appreciated that, in some embodiments, the process 1000 embodies a sub-process of one or more other process(es) depicted and/or described herein, for example the process 900.

At operation 1002, the apparatus 200 includes connection management circuitry 210, real-time digital signing circuitry 212, token generation and management circuitry 214, communications circuitry 208, input/output circuitry 206, processor 202, and/or a combination thereof, that receives a virtual object uploaded from a digital signor device. The digital signor device may transmit the virtual object to the apparatus 200. In some embodiments, the virtual object may be selected from a file system maintained by or otherwise accessible to the digital signor device. Alternatively or additionally, in some embodiments, the virtual object is captured via the digital signor device (e.g., as image data) and uploaded via transmission to the apparatus 200.

At operation 1004, the apparatus 200 includes connection management circuitry 210, real-time digital signing circuitry 212, token generation and management circuitry 214, communications circuitry 208, input/output circuitry 206, processor 202, and/or a combination thereof, that is uploaded from a digital signee device. The digital signee device may transmit the virtual object to the apparatus 200. In some embodiments, the virtual object may be selected from a file system maintained by or otherwise accessible to the digital signee device. Alternatively or additionally, in some embodiments, the virtual object is captured via the digital signee device (e.g., as image data) and uploaded via transmission to the apparatus 200.

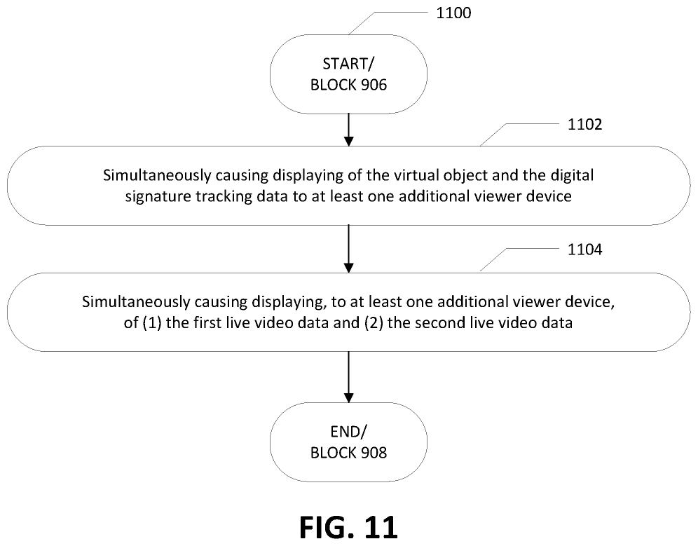

FIG. 11 illustrates a flowchart depicting operations of at least one example process for causing displaying to at least one viewer device, for example as part of a process for real-time digitally signing a virtual object, in accordance with at least one example embodiment of the present disclosure. In some embodiments, the process 1100 is embodied by computer program code stored on a non-transitory computer-readable storage medium of a computer program product configured for execution to perform the process as depicted and described. Alternatively or additionally, in some embodiments, the process 1100 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with a separate digital signee device, digital signor device, viewer device, and/or the like. For purposes of simplifying the description, the process 1100 is described as performed by and from the perspective of the apparatus 200.

The process 1100 begins at one of operation 1102. In some embodiments, the process 1100 begins after one or more operations depicted and/or described with respect to any one of the other processes described herein. For example, in some embodiments, the process 1100 begins after operation 906 as depicted and described with respect to FIG. 9. In this regard, some or all of the process 1100 may replace or supplement one or more blocks depicted and/or described with respect to any of the processes described herein. Upon completion of the process 1100, the flow of operations may terminate. Additionally or alternatively, as depicted, upon completion of the process 1100 in some embodiments, flow may return to one or more operation(s) of another process, such as the operation 908. It will be appreciated that, in some embodiments, the process 1100 embodies a sub-process of one or more other process(es) depicted and/or described herein, for example the process 900.

At operation 1102, the apparatus 200 includes connection management circuitry 210, real-time digital signing circuitry 212, token generation and management circuitry 214, communications circuitry 208, input/output circuitry 206, processor 202, and/or a combination thereof, that simultaneously causes displaying of the virtual object and the digital signature tracking data to at least one additional viewer device. The virtual object may be rendered via a user interface, canvas, or the like, displayed to the additional viewer device. It will be appreciated that the apparatus 200 may cause simultaneously displaying of the virtual object to any number of view devices. For example, in some embodiments, the viewer device may connect to a particular session maintained by the apparatus 200, for example between a digital signee device and a digital signor device.

At operation 1104, the apparatus 200 includes connection management circuitry 210, real-time digital signing circuitry 212, token generation and management circuitry 214, communications circuitry 208, input/output circuitry 206, processor 202, and/or a combination thereof, that simultaneously causes displaying, to at least one additional viewer device, of live video data. For example, in some embodiments, the apparatus 200 causes simultaneously displaying of first live video data associated with the digital signor device, and/or second live video data associated with the digital signee device. In some such embodiments, the live video data represents video data of the corresponding user, for example captured by a device's integrated webcam, peripheral camera, and/or the like. In this regard, in some such embodiments the additional viewer device may display the live video data for the digital signee device and digital signor device associated with a session, but no live video data associated with the additional viewer device(s) may be captured and/or depicted.

In some embodiments, the additional viewer device is connected to a shared session between at least the digital signee device and the digital signor device. In this regard, each additional viewer device may have access to the same data shared between the digital signor device and the digital signee device. For example, the apparatus 200 may facilitate transfer of the same data between the digital signor device, the digital signee device, and the additional viewer device(s) for use in rendering the same or similar interfaces. The additional viewer devices may render, in some embodiments, the virtual object, the digital signature tracking data, live video data for one or more devices, a live chat associated with the session, and/or the like.

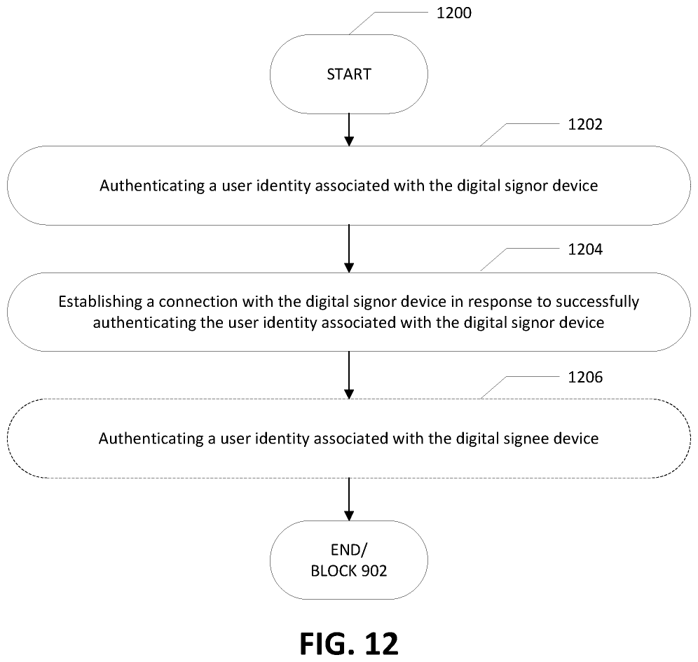

FIG. 12 illustrates a flowchart depicting operations of at least one example process for user authentication, for example as part of a process for real-time digitally signing a virtual object, in accordance with at least one example embodiment of the present disclosure. In some embodiments, the process 1200 is embodied by computer program code stored on a non-transitory computer-readable storage medium of a computer program product configured for execution to perform the process as depicted and described. Alternatively or additionally, in some embodiments, the process 1200 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with a separate digital signee device, digital signor device, viewer device, and/or the like. For purposes of simplifying the description, the process 1200 is described as performed by and from the perspective of the apparatus 200.

The process 1200 begins at one of operation 1202. In some embodiments, the process 1200 begins after one or more operations depicted and/or described with respect to any one of the other processes described herein. In this regard, some or all of the process 1200 may replace or supplement one or more blocks depicted and/or described with respect to any of the processes described herein. Upon completion of the process 1200, the flow of operations may terminate. Additionally or alternatively, as depicted, upon completion of the process 1200 in some embodiments, flow may return to one or more operation(s) of another process, such as the operation 902. It will be appreciated that, in some embodiments, the process 1200 embodies a sub-process of one or more other process(es) depicted and/or described herein, for example the process 900.

At operation 1202, the apparatus 200 includes connection management circuitry 210, real-time digital signing circuitry 212, token generation and management circuitry 214, communications circuitry 208, input/output circuitry 206, processor 202, and/or a combination thereof, that authenticates a user identity associated with the digital signor device. In some embodiments, the apparatus 200 receives user credentials inputted via the digital signor device, such as a username and password, and authenticates such user credentials against stored user credentials to identify a particular user account corresponding to the digital signor device, and begin an authenticated session associated with that digital signor device. Alternatively or additionally, in some embodiments, the apparatus 200 prompts for connection to one or more social media accounts to validate the social media accounts match an asserted identity associated with the digital signor device. For example, in some embodiments, the apparatus 200 prompts for login information and/or other data that indicates access to a plurality of social media accounts identified as associated with a particular identity, or manually indicated or determined to match a particular user identity.

At operation 1204, the apparatus 200 includes connection management circuitry 210, real-time digital signing circuitry 212, token generation and management circuitry 214, communications circuitry 208, input/output circuitry 206, processor 202, and/or a combination thereof, that establishes a connection with the digital signor device in response to successfully authenticating the user identity associated with the digital signor device. For example, in some embodiments, the apparatus 200 generates and/or maintains a session associated with the digital signor device. The session may be accessed to perform a digital signing process, for example in conjunction with one or more digital signee device(s) that subsequently access the session.

At operation 1206, the apparatus 200 includes connection management circuitry 210, real-time digital signing circuitry 212, token generation and management circuitry 214, communications circuitry 208, input/output circuitry 206, processor 202, and/or a combination thereof, that authenticates a user identity associated with the digital signee device. In some embodiments, a process associated with authenticating a user identity of a digital signee is less intensive than authenticating user identity of a digital signor. For example, in some embodiments, the apparatus 200 receives user credentials inputted via the digital signee device, such as a username and password, and authenticates such user credentials against stored user credentials to identify a particular user account corresponding to the digital signee device. The apparatus 200 may begin an authenticated session associated with the digital signee device in response to authentication of the user credentials.

Alternatively or additionally, in some embodiments, the apparatus 200 prompts for connection to one or more social media accounts to validate the social media accounts match an asserted identity associated with the digital signee device. For example, in some embodiments, the apparatus 200 prompts for login information and/or other data that indicates access to a plurality of social media accounts identified as associated with a particular identity, or manually indicated or determined to match a particular user identity.

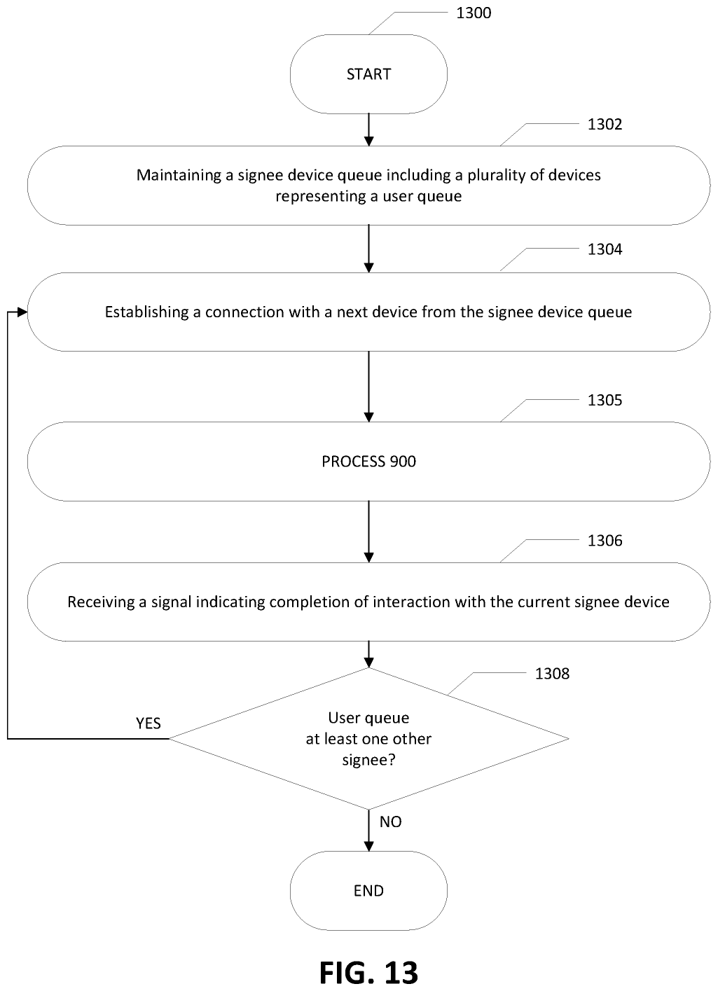

FIG. 13 illustrates a flowchart depicting operations of at least one example process for managing a signee queue, for example as part of a process for real-time digitally signing a virtual object, in accordance with at least one example embodiment of the present disclosure. In some embodiments, the process 1300 is embodied by computer program code stored on a non-transitory computer-readable storage medium of a computer program product configured for execution to perform the process as depicted and described. Alternatively or additionally, in some embodiments, the process 1300 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with a separate digital signee device, digital signor device, viewer device, and/or the like. For purposes of simplifying the description, the process 1300 is described as performed by and from the perspective of the apparatus 200.

The process 1300 begins at one of operation 1302. In some embodiments, the process 1300 begins after one or more operations depicted and/or described with respect to any one of the other processes described herein. In this regard, some or all of the process 1300 may replace or supplement one or more blocks depicted and/or described with respect to any of the processes described herein. Upon completion of the process 1300, the flow of operations may terminate. Additionally or alternatively, as depicted, upon completion of the process 1300 in some embodiments, flow may return to one or more operation(s) of another process.

At operation 1302, the apparatus 200 includes connection management circuitry 210, real-time digital signing circuitry 212, token generation and management circuitry 214, communications circuitry 208, input/output circuitry 206, processor 202, and/or a combination thereof, that maintains a signee device queue including a plurality of devices representing a user queue. The signee device queue may correspond to any number of digital signee devices queued for participation in a digital signing process with a particular digital signor device. In this regard, the signee device queue may include data identifying a plurality of device signee devices. The signee device queue in some embodiments embodies an ordered list of such digital signee devices. For example, in some embodiments, a digital signee device may provide input to the apparatus 200 to join a signee device queue, in which an identifier associated with the digital signee device is stored to the signee device queue at the next available position in the signee device queue. The apparatus 200 may maintain a signee device queue for each session associated with a different digital signor device. In some embodiments, the signee device queue may include zero or more identifiers.

At operation 1304, the apparatus 200 includes connection management circuitry 210, real-time digital signing circuitry 212, token generation and management circuitry 214, communications circuitry 208, input/output circuitry 206, processor 202, and/or a combination thereof, that establishes a connection with a next device from the signee device queue. In some embodiments, the apparatus 200 pops the next device from the signee device queue, for example from the top spot in the ordered list. Each remaining digital signee device may advance in position within the ordered list. In some embodiments, the connection enables performance of a digital signing process between the next device embodying a digital signee device and a particular digital signor device similarly connected to the session.

At operation 1305, the flow proceeds to the process 900 as depicted and described with respect to FIG. 9. In this regard, the apparatus 200 may perform the process 900 to facilitate a digital signing process between the next device representing a current digital signee device and a corresponding digital signor device connected to the same session.

At operation 1306, the apparatus 200 includes connection management circuitry 210, real-time digital signing circuitry 212, token generation and management circuitry 214, communications circuitry 208, input/output circuitry 206, processor 202, and/or a combination thereof, that receives a signal indicating completion of interaction with the current signee device. In some embodiments, the signal is received from the digital signor device, for example in response to user input via the digital signor device. Alternatively or additionally, in some embodiments, the signal is received in response to termination of connection with the current digital signee device.

At operation 1308, the apparatus 200 includes connection management circuitry 210, real-time digital signing circuitry 212, token generation and management circuitry 214, communications circuitry 208, input/output circuitry 206, processor 202, and/or a combination thereof, that determines whether the user queue includes at least one other signee. For example, in some embodiments, the apparatus 200 identifies a length of the user queue. In other embodiments, the apparatus 200 attempts a pop of the top spot in the user queue. In a circumstance where the apparatus 200 determines that the user queue includes at least one other signee, flow returns to the operation 1304. In this regard, the apparatus 200 may continue to process until the entire user queue is empty, or until one or more other triggering condition(s) is/are met, for example a particular set length of time. It will be appreciated that the user queue may update in size dynamically as users leave and/or enter the user queue as other digital signing processes occur.

In circumstances where the user queue is empty, in some embodiments the session may close and the flow may end. Alternatively or additionally, in some embodiments, the apparatus 200 continues to maintain the user queue until a new digital signee device enters the user queue.

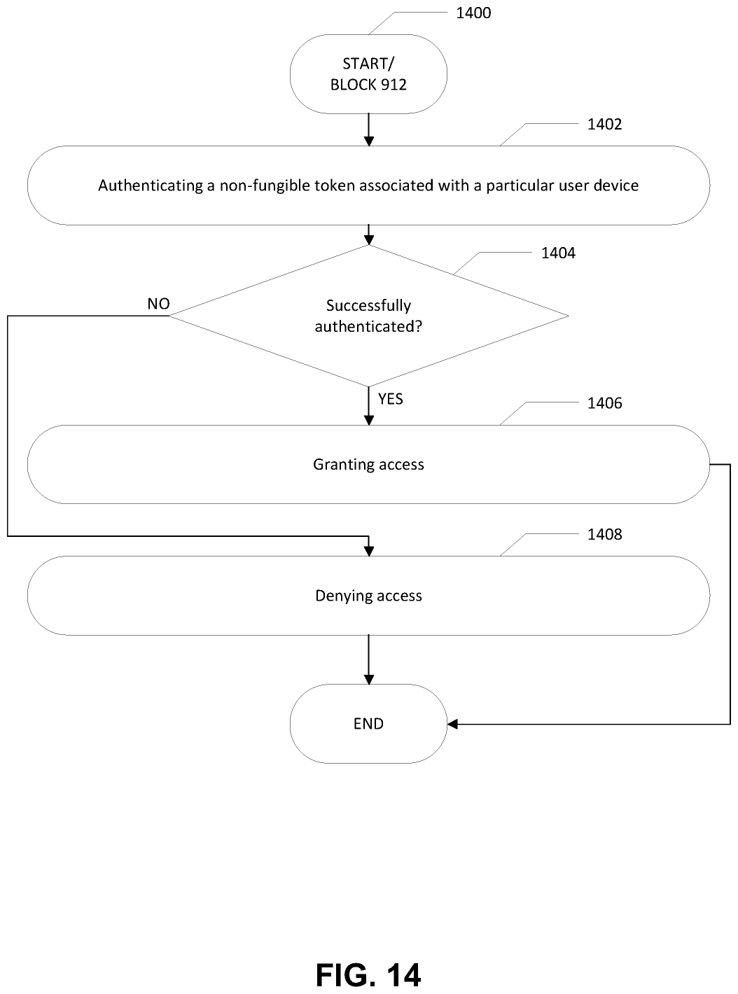

FIG. 14 illustrates a flowchart depicting operations of at least one example process for facilitating access based at least in part on authentication of a NFT associated with a digitally signed virtual object, for example as part of a process for real-time digitally signing a virtual object, in accordance with at least one example embodiment of the present disclosure. In some embodiments, the process 1400 is embodied by computer program code stored on a non-transitory computer-readable storage medium of a computer program product configured for execution to perform the process as depicted and described. Alternatively or additionally, in some embodiments, the process 1400 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with a separate digital signee device, digital signor device, viewer device, and/or the like. For purposes of simplifying the description, the process 1400 is described as performed by and from the perspective of the apparatus 200.

The process 1400 begins at one of operation 1402. In some embodiments, the process 1400 begins after one or more operations depicted and/or described with respect to any one of the other processes described herein. For example, in some embodiments, the process 1400 begins after operation 906 as depicted and described with respect to FIG. 9. In this regard, some or all of the process 1400 may replace or supplement one or more blocks depicted and/or described with respect to any of the processes described herein. Upon completion of the process 1400, the flow of operations may terminate. Additionally or alternatively, as depicted, upon completion of the process 1400 in some embodiments, flow may return to one or more operation(s) of another process, such as the operation 908. It will be appreciated that, in some embodiments, the process 1400 embodies a sub-process of one or more other process(es) depicted and/or described herein, for example the process 900.

At operation 1402, the apparatus 200 includes connection management circuitry 210, real-time digital signing circuitry 212, token generation and management circuitry 214, communications circuitry 208, input/output circuitry 206, processor 202, and/or a combination thereof, that authenticates a digital asset, such as an NFT, associated with a particular user device. In some embodiments, a blockchain including or otherwise to which the NFT is stored is utilized to authenticate the particular user device via a particular user identifier. For example, in some embodiments, the apparatus 200 receives data from the user device, such as a particular digital signee device, that is utilized to verify via the blockchain that the NFT is owned by the particular user device. The data may be cryptographically secured for sharing (e.g., as a public key) without jeopardizing the unique identity of the particular user device.

At operation 1404, the apparatus 200 includes connection management circuitry 210, real-time digital signing circuitry 212, token generation and management circuitry 214, communications circuitry 208, input/output circuitry 206, processor 202, and/or a combination thereof, that determines whether the NFT was successfully authenticated. In circumstances where the NFT was not authenticated, flow proceeds to operation 1408. At operation 1408, the apparatus 200 includes connection management circuitry 210, real-time digital signing circuitry 212, token generation and management circuitry 214, communications circuitry 208, input/output circuitry 206, processor 202, and/or a combination thereof, that denies access. In some embodiments, the apparatus 200 outputs a denial notification, or otherwise transmits a signal indicating that access was denied. The denial notification or signal may prevent physical access to a particular location, fail to initiate a subsequent process, and/or the like.

In circumstances where the NFT was authenticated, flow proceeds to operation 1406. At operation 1406, the apparatus 200 includes connection management circuitry 210, real-time digital signing circuitry 212, token generation and management circuitry 214, communications circuitry 208, input/output circuitry 206, processor 202, and/or a combination thereof, that grants access. In some embodiments, the apparatus 200 outputs an access granted notification, or otherwise transmits a signal indicating that access was granted. The access granted notification or signal may enable physical access to a particular location, initiate a subsequent process, and/or the like. For example, the granted access may perform a particular process via the digital signee device. In some embodiments, access granted at operation 1406 provides access to particular computer-implemented functionality.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML, page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. An apparatus for real-time digitally signing a virtual object, the apparatus comprising at least one processor and at least one non-transitory memory including computer-coded instructions thereon, the computer coded instructions, with the at least one processor, cause the apparatus to:
receive a virtual object;
simultaneously cause displaying of the virtual object to at least a digital signor device and a digital signee device;
simultaneously cause displaying, at each of the digital signor device and the digital signee device, of:
(1) first live video data associated with the digital signor device;
receive digital signature tracking data representing a digital signature input via the digital signor device, wherein the digital signature tracking data is associated with positional data relative to the virtual object;
in near-real-time, cause displaying of the digital signature tracking data at least at the digital signee device; and
cause generation, in near-real-time, of a digital asset representing the virtual object and the digital signature, the digital asset digitally linked to a signee identifier associated with the digital signee device.

2. The apparatus of claim 1, wherein the apparatus further simultaneously causes displaying, at each of the digital signor device and the digital signee device, of (2) second live video data associated with the digital signee device.

3. The apparatus of claim 1, wherein to receive the virtual object the apparatus is caused to:
receive the virtual object via an upload from the digital signee device.

4. The apparatus of claim 1, wherein to receive the virtual object the apparatus is caused to:
receive the virtual object via an upload from the digital signor device.

5. The apparatus of claim 1, the apparatus further caused to:
simultaneously cause displaying of the virtual object and the digital signature tracking data to at least one additional viewer device.

6. The apparatus of claim 1, the apparatus further caused to:
simultaneously cause displaying, to at least one additional viewer device, of (1) the first live video data and (2) the second live video data.

7. The apparatus of claim 1, the apparatus further caused to:
authenticate a user identity associated with the digital signor device, wherein the user identity is authenticated via at least one social media account.

8. The apparatus of claim 6, wherein the user identity is authenticated via a plurality of social media accounts.

9. The apparatus of claim 1, the apparatus further caused to:
authenticate a user identity associated with the digital signee device.

10. The apparatus of claim 1, the apparatus further caused to:
maintain a signee device queue comprising a plurality of devices representing a user queue; and
establish a connection with a next device from the signee device queue, wherein the next device embodies the digital signee device during the connection.

11. The apparatus of claim 9, wherein the connection is established associated with the digital signor device and the digital signee device is updated one at a time via the signee device queue.

12. The apparatus of claim 1, the apparatus further caused to:
authenticate the digital asset associated with a particular user device; and
grant access associated with the particular user device based at least in part on authentication of the digital asset.

13. The apparatus of claim 1, wherein the first live video data comprises a captured video associated with a signor during input of the digital signature input.

14. The apparatus of claim 1, the apparatus further caused to:
provide at least one control for manipulating the digital signature with respect to the virtual object.

15. A computer-implemented method comprising:
receiving a virtual object;
simultaneously causing displaying of the virtual object to at least a digital signor device and a digital signee device;
simultaneously causing displaying, at each of the digital signor device and the digital signee device, of:
(1) first live video data associated with the digital signor device;
receiving digital signature tracking data representing a digital signature input via the digital signor device, wherein the digital signature tracking data is associated with positional data relative to the virtual object;
in near-real-time, causing displaying of the digital signature tracking data at least at the digital signee device; and
causing generation, in near-real-time, of a digital asset representing the virtual object and the digital signature, the digital asset digitally linked to a signee identifier associated with the digital signee device.

16. The computer-implemented method of claim 14, the computer-implemented method further comprising:
simultaneously causing displaying of the virtual object and the digital signature tracking data to at least one additional viewer device.

17. The computer-implemented method of claim 14, the computer-implemented method further comprising:
maintaining a signee device queue comprising a plurality of devices representing a user queue; and
establishing a connection with a next device from the signee device queue, wherein the next device embodies the digital signee device during the connection.

18. The computer-implemented method of claim 16, wherein the connection is established associated with the digital signor device and the digital signee device is updated one at a time via the signee device queue.

19. The computer-implemented method of claim 14, the computer-implemented method further comprising:
authenticating the digital asset associated with a particular user device; and
granting access associated with the particular user device based at least in part on authentication of the digital asset.

20. A computer program product comprising at least one non-transitory computer-readable storage medium having computer program code stored thereon that, in execution with at least one processor, is configured for:
receiving a virtual object;
simultaneously causing displaying of the virtual object to at least a digital signor device and a digital signee device;
simultaneously causing displaying, at each of the digital signor device and the digital signee device, of:
(1) first live video data associated with the digital signor device;
receiving digital signature tracking data representing a digital signature input via the digital signor device, wherein the digital signature tracking data is associated with positional data relative to the virtual object;
in near-real-time, causing displaying of the digital signature tracking data at least at the digital signee device; and
causing generation, in near-real-time, of a digital asset representing the virtual object and the digital signature, the digital asset digitally linked to a signee identifier associated with the digital signee device.
